(19) United States
(12) Patent Application Publication
(10) Pub. No.: US 2026/0172639 A1
(43) Pub. Date: Jun. 18, 2026

(54) METHOD, DEVICE, AND STORAGE MEDIUM FOR PRESENTING A BULLET COMMENT

(71) Applicant: Beijing Zitiao Network Technology Co., Ltd., Beijing (CN)

(72) Inventors: Shengjie Wang, Beijing (CN); Xun YANG, Beijing (CN); Peipei WU, Beijing (CN); Liyue JI, Beijing (CN); Lichen HUANG, Beijing (CN)

(21) Appl. No.: 19/125,257

(22) PCT Filed: Oct. 27, 2023
(86) PCT No.: PCT/CN2023/127049

§ 371 Date: Apr. 28, 2025

(30) Foreign Application Priority Data
Oct. 28, 2022 (CN) 202211338814.7
Feb. 7, 2023 (CN) 202310125056.9
Feb. 7, 2023 (CN) 202310134075.8

(51) Int. Cl. H04N 21/4788; G06T 19/00; H04N 21/81

(52) U.S. Cl. CPC H04N 21/4788; G06T 19/00; H04N 21/816

(57) ABSTRACT

A method, a device, and a storage medium for presenting a bullet comment are provided. The method includes: determining at least one layer of surrounding bullet comment tracks in a virtual space; and in response to any current bullet comment obtained in the virtual space, determining a presentation position of the current bullet comment in the at least one layer of surrounding bullet comment tracks, and presenting the current bullet comment at the presentation position.

The present disclosure claims priority to Chinese Patent Application No. 202211338814.7, filed on Oct. 28, 2022, Chinese Patent Application No. 202310125056.9, filed on Feb. 7, 2023, and Chinese Patent Application No. 202310134075.8, filed on Feb. 7, 2023, which are incorporated herein by reference in their entireties as a part of the present disclosure.

### TECHNICAL FIELD

Embodiments of the present disclosure relate to a method, apparatus, a device, and a storage medium for presenting a bullet comment.

### BACKGROUND

At present, application scenarios of XR technologies are more and more extensive, including virtual reality (VR for short), augmented reality (AR for short), mixed reality (MR for short), and the like. In various virtual scenarios, a user can engage in immersive experience of a real virtual scenario by performing various interactions with a corresponding virtual object.

Generally, a bullet comment interactive interface is displayed in front of a user in a virtual space, and various bullet comment messages sent by users in the virtual space are presented in the bullet comment interactive interface. The bullet comment presentation in the virtual space is relatively single, and there is a certain presentation limitation.

### SUMMARY

The present disclosure provides a method, apparatus, a device, and a storage medium for presenting a bullet comment, to achieve bullet comment surrounding presentation in a virtual space through at least one layer of surrounding bullet comment tracks, thereby enhancing the diversity and interactive interest of bullet comment presentation in the virtual space, and improving the all-round immersive experience of a user in the virtual space.

Embodiments of the present disclosure provide a method for presenting a bullet comment, applicable in an XR device. The method includes:
determining at least one layer of surrounding bullet comment tracks in a virtual space; and
in response to any current bullet comment obtained in the virtual space, determining a presentation position of the current bullet comment in the at least one layer of surrounding bullet comment tracks, and presenting the current bullet comment at the presentation position.

Embodiments of the present disclosure provide an apparatus for presenting a bullet comment, configured in an XR device. The apparatus includes:
a bullet comment track determining module, configured to determine at least one layer of surrounding bullet comment tracks in a virtual space; and
a bullet comment presenting module, configured to in response to any current bullet comment obtained in the virtual space, determine a presentation position of the current bullet comment in the at least one layer of surrounding bullet comment tracks, to present the current bullet comment at the presentation position.

Embodiments of the present disclosure further provide a method for displaying a bullet comment. The method for displaying a bullet comment includes:
generating at least one annular track in a virtual space;
obtaining display information of bullet comment, the display information of the bullet comment including content of the bullet comment, track information about the bullet comment's birth, space information occupied by the bullet comment on the track, and disappearance position information of the bullet comment on the track; and
displaying the bullet comment on the annular track based on the display information of the bullet comment, the bullet comment moving on the annular track.

Embodiments of the present disclosure further provide an apparatus for displaying a bullet comment. The apparatus for displaying a bullet comment includes:
a generation module, configured to generate at least one annular track in a virtual space;
an obtaining module, configured to obtain display information of bullet comment, the display information of the bullet comment including content of the bullet comment, track information about the bullet comment's birth, space information occupied by the bullet comment on the track, and disappearance position information of the bullet comment on the track; and
a display module, configured to display the bullet comment on the annular track based on the display information of the bullet comment, the bullet comment moving on the annular track.

Embodiments of the present disclosure further provide a method for displaying a bullet comment. The method for displaying a bullet comment includes:
obtaining a content scene of a virtual space;
determining a target display manner of bullet comment based on the content scene; and
displaying the bullet comment in the virtual space based on the target display manner.

Embodiments of the present disclosure further provide an apparatus for displaying a bullet comment. The apparatus for displaying a bullet comment includes:
a scene obtaining module, configured to obtain a content scene of a virtual space;
a determining module, configured to determine a target display manner of bullet comment based on the content scene; and
a display module, configured to display the bullet comment in the virtual space based on the target display manner.

Embodiments of the present disclosure provide an electronic device. The electronic device includes:
a processor and a memory, the memory being configured to store a computer program, and the processor being configured to call and run the computer program stored in the memory, to execute the method for presenting a bullet comment or the method for displaying a bullet comment provided in any one of the embodiments of the present disclosure.

Embodiments of the present disclosure provide a computer-readable storage medium configured to store a computer program, the computer program causing a computer to execute the method for presenting a bullet comment or the method for displaying a bullet comment provided in any one of the embodiments of the present disclosure.

Embodiments of the present disclosure provide a computer program product including a computer program or instructions, the computer program or the instructions causing a computer to execute the method for presenting a bullet comment or the method for displaying a bullet comment provided in any one of the embodiments of the present disclosure.

With the technical solution of the present disclosure, after entering a virtual space, at least one layer of surrounding bullet comment tracks in the virtual space is determined first. Then, for any current bullet comment obtained in the virtual space, a presentation position of the current bullet comment in the at least one layer of surrounding bullet comment tracks is determined to present the current bullet comment at the presentation position, thereby achieving bullet comment surrounding presentation in the virtual space, facilitating a user to browse bullet comment in all directions in the virtual space, enhancing the diversity and interactive interest of bullet comment presentation in the virtual space, and improving the all-round immersive experience of the user in the virtual space.

### BRIEF DESCRIPTION OF DRAWINGS

In order to more clearly describe the technical solutions in the embodiments of the present disclosure, the accompanying drawings for describing the embodiments will be briefly described below. It is clear that the accompanying drawings in the following description are merely some embodiments of the present disclosure. For those of ordinary skill in the art, other drawings may also be obtained based on these accompanying drawings without creative efforts.

FIG. 1 is a flowchart of a method for presenting a bullet comment according to an embodiment of the present disclosure;

FIG. 2 is an exemplary schematic diagram of at least one layer of surrounding bullet comment tracks according to an embodiment of the present disclosure;

FIG. 3 is a flowchart of a method for a specific determination process of at least one layer of surrounding bullet comment tracks according to an embodiment of the present disclosure;

FIG. 4 is a schematic diagram of a principle of determining at least one layer of surrounding bullet comment tracks according to an embodiment of the present disclosure;

FIG. 5 is a flowchart of a method for a bullet comment presentation process in at least one layer of surrounding bullet comment tracks according to an embodiment of the present disclosure;

FIG. 6 is a schematic diagram of a principle of bullet comment presentation in at least one layer of surrounding bullet comment tracks according to an embodiment of the present disclosure;

FIG. 7 is a flowchart of another method for presenting a bullet comment according to an embodiment of the present disclosure;

FIG. 8 is an exemplary schematic diagram of a plurality of bullet comment production areas delimited in at least one layer of surrounding bullet comment tracks according to an embodiment of the present disclosure;

FIG. 9 is a schematic diagram of an apparatus for presenting a bullet comment according to an embodiment of the present disclosure;

FIG. 10 is a flowchart of a method for displaying a bullet comment according to an embodiment of the present disclosure;

FIG. 11 is a schematic diagram of a bullet comment displayed on an annular track;

FIG. 12 is a schematic diagram of a bending process of a mesh corresponding to a bullet comment;

FIG. 13 is a flowchart of a method for obtaining display information of a new bullet comment according to an embodiment of the present disclosure;

FIG. 14 is a schematic diagram of a host state interval and a guest state interval of a track;

FIG. 15 is a flowchart of a method for obtaining display information of a new bullet comment according to an embodiment of the present disclosure;

FIG. 16 is a schematic structural diagram of an apparatus for displaying a bullet comment according to an embodiment of the present disclosure;

FIG. 17 is a schematic flowchart of a method for displaying a bullet comment according to an embodiment of the present disclosure;

FIG. 18 is a schematic diagram of a bullet comment presentation area divided in a virtual space according to an embodiment of the present disclosure;

FIG. 19 is a schematic flowchart of another method for displaying a bullet comment according to an embodiment of the present disclosure;

FIG. 20a is a front view of bullet comments displayed in a virtual space in a landscape scrolling manner according to an embodiment of the present disclosure;

FIG. 20b is a top view of bullet comments displayed in a virtual space in a radian surrounding manner according to an embodiment of the present disclosure;

FIG. 20c is a top view of bullet comments displayed in a virtual space in a 180-degree surrounding manner according to an embodiment of the present disclosure;

FIG. 20d is a top view of bullet comments displayed in a virtual space in a 360-degree surrounding manner according to an embodiment of the present disclosure;

FIG. 21 is a schematic flowchart of a further method for displaying a bullet comment according to an embodiment of the present disclosure;

FIG. 22a is a schematic diagram of different bullet comment track zoom ratios corresponding to a reciprocating stacking presentation manner according to an embodiment of the present disclosure;

FIG. 22b is a schematic diagram of different bullet comment track zoom ratios corresponding to a forward ladder presentation manner according to an embodiment of the present disclosure;

FIG. 22c is a schematic diagram of different bullet comment track zoom ratios corresponding to an inverted ladder presentation manner according to an embodiment of the present disclosure;

FIG. 23 is a front view of bullet comments displayed in a virtual space in a landscape scrolling manner and a reciprocating stacking presentation manner according to an embodiment of the present disclosure;

FIG. 24 is a schematic block diagram of an apparatus for displaying a bullet comment according to an embodiment of the present disclosure; and

FIG. 25 is a schematic block diagram of an electronic device according to an embodiment of the present disclosure.

### DETAILED DESCRIPTION

The technical solutions in the embodiments of the present disclosure will be described below clearly and completely with reference to the accompanying drawings in the embodiments of the present disclosure. It is clear that the described embodiments are merely some but not all of the embodiments of the present disclosure. All other embodiments obtained by those of ordinary skill in the art based on the embodiments of the present disclosure without creative efforts shall fall within the protection scope of the present disclosure.

It should be noted that the terms “first,” “second,” and the like in the specification, claims, and accompanying drawings of the present disclosure are intended to distinguish between similar objects but do not necessarily indicate a specific order or sequence. It should be understood that the data termed in such a way are interchangeable in proper circumstances so that the embodiments of the present disclosure described herein can be implemented in orders except the order illustrated or described herein. Moreover, the terms “include,” “have,” or any other variant thereof are intended to cover non-exclusive inclusion. For example, a process, method, system, product, or server that includes a list of steps or units is not necessarily limited to those expressly listed steps or units, but may include other steps or units not expressly listed or inherent to such process, method, product, or device.

In the embodiments of the present disclosure, the words “exemplary” or “such as” are used to represent examples, illustrations, or explanations. Any embodiment or design described as “exemplary” or “such as” in the embodiments of the present disclosure shall not be construed as being more preferred or more advantageous than other embodiments or designs. Rather, the use of words such as “exemplary” or “such as” is intended to present the concepts related in a specific manner.

To facilitate understanding of the embodiments of the present disclosure, before describing the embodiments of the present disclosure, some concepts involved in all the embodiments of the present disclosure are appropriately explained below, as follows:

1) Virtual reality (VR for short) is a technology for creating and experiencing a virtual world. A virtual environment is determined and generated. The virtual environment is a multi-source information (virtual reality mentioned herein includes at least visual perception, and may further include auditory perception, tactile perception, motion perception, and even gustatory perception, olfactory perception, etc.). The integration of interactive three-dimensional dynamic scenes of the virtual environment and entity behaviors is implemented by simulating. A user is immersed in the simulated virtual reality environment, and various applications of virtual environments such as maps, games, videos, education, healthcare, simulation, collaborative training, sales, assistance in manufacturing, maintenance, and repair are implemented.

2) A virtual reality device (VR device) is a terminal for implementing a virtual reality effect, and is usually provided in the form of glasses, a head mount display (HMD for short), or contact lenses to implement visual perception and perception in other forms. Certainly, the form implemented by the virtual reality device is not limited thereto, and may be further miniaturized or enlarged as required.

Optionally, the virtual reality device described in the embodiments of the present disclosure may include but is not limited to the following types:

2.1) A computer virtual reality (PCVR) device, which uses a PC to perform related calculation and data output of virtual reality functions, and an external PC virtual reality device uses data output by the PC to implement the virtual reality effect.

2.2) A mobile virtual reality device that supports a mobile terminal (such as a smart phone) to be set in various ways (such as a head mount display provided with a dedicated card slot), and is connected to the mobile terminal in a wired or wireless manner. The mobile terminal performs related calculation of virtual reality functions, and outputs data to the mobile virtual reality device. For example, a virtual reality video is watched through an APP of the mobile terminal.

2.3) An integrated virtual reality device integrates a processor for performing related calculation of virtual functions, and therefore has an independent virtual reality input and output function, and does not need to be connected to a PC or a mobile terminal, and has high freedom of use.

3) Augmented reality (AR for short) is a technology that calculates camera posture parameters in the real world (or a three-dimensional world or an actual world) in real time during the process in which the camera collects an image and adds virtual elements to the image collected by a camera according to the camera posture parameters. The virtual elements include but are not limited to images, videos, and three-dimensional models. The goal of AR technology is to splice the virtual world onto the real world for interaction on a screen.

4) Mixed reality (MR for short) is a technology that combines the real and virtual worlds to create a new environment and realize visualization, where a physical entity and a digital object coexist and can interact in real time to simulate a real object. MR combines reality, augmented reality, augmented virtuality, and virtual reality technologies. MR is a synthetic product of virtual reality (VR) and augmented reality (AR), and is an expansion and extension of VR technology. By presenting a virtual scene in a real scene, the realism of a user experience can be enhanced. The MR field involves computer vision. Computer vision is a science of studying how to enable a machine to “see”. More specifically, computer vision refers to machine vision such as object recognition, tracking, and measurement performed by a camera and a computer instead of human eyes, and further image processing is performed, to obtain an image processed by a computer, which is more suitable for human eyes to observe or is transmitted to an instrument for detection.

In other words, MR is a simulated setting that integrates computer-created sensory input (for example, a virtual object) with sensory input or a representation thereof from a physical setting. In some MR settings, the computer-created sensory input may be adapted to changes in the sensory input from the physical setting. In addition, some electronic systems for presenting MR settings may monitor an orientation and/or position relative to the physical setting, so that the virtual object can interact with the real object (that is, a physical element from the physical setting or a representation thereof). For example, the system may monitor motion, so that a virtual plant appears to be stationary relative to a physical building.

5) Extended reality (XR for short) refers to all real and virtual combined environments and human-computer interaction generated by computer technology and a wearable device, and includes various forms such as virtual reality (VR), augmented reality (AR), and mixed reality (MR).

6) A virtual scene (also referred to as a virtual space) is a virtual scene displayed (or provided) when an application runs on an electronic device. The virtual scene may be a simulation environment of a real world, a semi-simulated and semi-fictional virtual scene, or a purely fictional virtual scene. The virtual scene may be any one of a two-dimensional virtual scene, a 2.5-dimensional virtual scene, and a three-dimensional virtual scene, and the embodiments of the present disclosure do not limit the dimension of the virtual scene. For example, the virtual scene may include the sky, land, an ocean, etc., and the land may include environmental elements such as a desert and a city.

After some concepts involved in the embodiments of the present disclosure are described, a method for displaying a bullet comment provided in the embodiments of the present disclosure is specifically described below with reference to the accompanying drawings. For the same content, reference is made to the description of the foregoing embodiments, and details of the same content will not be repeated.

To solve the problem of the singleness of bullet comment presentation when various bullet comments are presented on the bullet comment interactive interface in front of a user in the virtual space, the inventive concept of the present disclosure is to: set at least one layer of surrounding bullet comment tracks in the virtual space, to present various bullet comments in the virtual space in all directions. For any current bullet comment obtained in the virtual space, a presentation position of the current bullet comment in the at least one layer of surrounding bullet comment tracks is determined based on bullet comments that have been presented in the at least one layer of surrounding bullet comment tracks, to present the current bullet comment at the presentation position, thereby achieving bullet comment surrounding presentation in the virtual space, facilitating a user to browse bullet comments in all directions in the virtual space, and enhancing the diversity and interactive interest of bullet comment presentation in the virtual space.

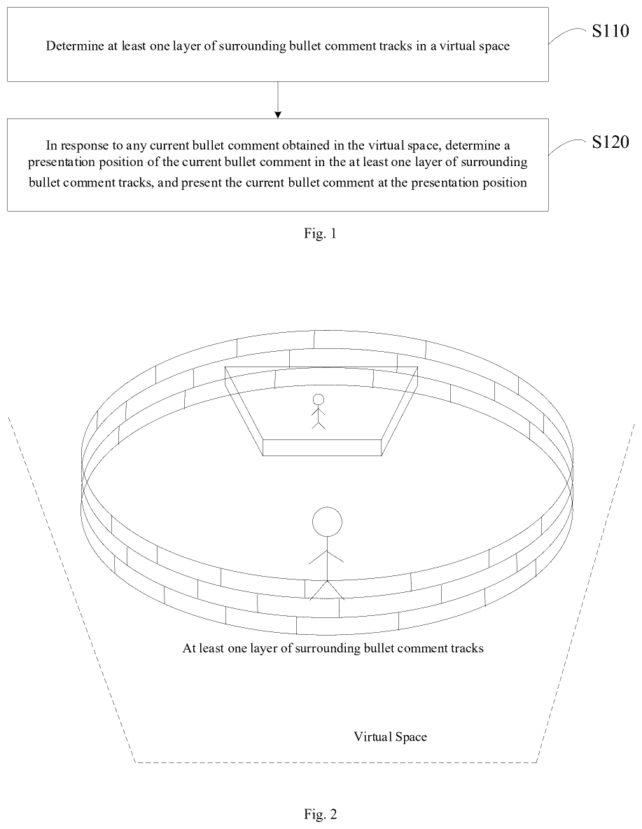

FIG. 1 is a flowchart of a method for presenting a bullet comment according to an embodiment of the present disclosure. The method may be applicable in an XR device, but is not limited thereto. The method may be performed by an apparatus for presenting a bullet comment provided in the present disclosure, where the apparatus for presenting a bullet comment may be implemented by any software and/or hardware. For example, the apparatus for presenting a bullet comment may be configured in an electronic device such as AR/VR/MR that can simulate a virtual scene, and the present disclosure does not impose any limitation on a specific type of the electronic device.

Specifically, as shown in FIG. 1, the method may include the following steps:

S110: Determine at least one layer of surrounding bullet comment tracks in a virtual space.

The virtual space may be a corresponding virtual environment simulated by the XR device for a real interactive scene selected by any user, so that corresponding interactive information is displayed in the virtual space. The virtual space may be a simulation environment of a real world, a semi-simulated and semi-fictional virtual scene, or a purely fictional virtual scene.

For example, a user selects a specific type of live broadcast scene to construct a corresponding virtual live broadcast environment, which is used as the virtual space in the present disclosure, so that viewers enter the virtual space to implement corresponding live broadcast interaction. Generally, after wearing an XR device, the user enters a provided virtual space formed by the fusion of a real scene and a virtual scene.

In one aspect, after entering the virtual space, corresponding bullet comments are presented in the virtual space by default. Therefore, after entering the virtual space, the present disclosure directly determines an object for presenting the bullet comments in the virtual space, that is, at least one layer of surrounding bullet comment tracks in the present disclosure.

In another aspect, in the virtual space, users send corresponding bullet comment messages for various scene content displayed, to implement user interaction in the virtual space. To prevent the bullet comment from blocking various scene content displayed in the virtual space, when entering the virtual space, the bullet comment is usually hidden, so that the user can actively enable the bullet comment when there is a need to view the bullet comment. Therefore, to enable the bullet comment in the virtual space conveniently, the present disclosure sets a bullet comment control in the virtual space, to guide the user to perform a corresponding bullet comment enabling operation. Therefore, after entering the virtual space, if the bullet comment is not currently enabled and the user needs to view the bullet comment, the user performs a corresponding trigger operation on the bullet comment control in the virtual space. When a trigger operation performed by the user for the bullet comment control is detected, a corresponding bullet comment enabling instruction is generated to determine an object for presenting the bullet comment in the virtual space, that is, at least one layer of surrounding bullet comment tracks in the present disclosure.

In addition, considering that the bullet comment presentation on the bullet comment interactive interface in front of the user in the virtual space is relatively single, and does not support the all-round browsing of the bullet comment when the user's head rotates in the virtual space. Therefore, in combination with the all-round browsing requirement of the user for the bullet comment in the virtual space and the large quantity of the bullet comment, the present disclosure sets at least one layer of surrounding bullet comment tracks in the virtual space.

The at least one layer of surrounding bullet comment tracks may be circular tracks surrounding the user in the virtual space, and a surrounding angle of the at least one layer of surrounding bullet comment tracks facing the user may be adaptively adjusted according to a panoramic angle in the virtual space, to adapt to the panoramic rotation angle of the user in the virtual space. For example, the at least one layer of surrounding bullet comment tracks may be a 360-degree surrounding track set for the user, or may be a 270-degree surrounding track set for the user. This is not limited in the present disclosure.

In addition, a quantity of layers of the at least one layer of surrounding bullet comment tracks in the present disclosure is not limited, and may be set according to a maximum quantity of bullet comments that can be presented in the virtual space, so that the at least one layer of surrounding bullet comment tracks supports the normal presentation of the bullet comment in the maximum quantity of bullet comments, to avoid an overcrowded phenomenon of the bullet comment presented in the at least one layer of surrounding bullet comment tracks.

In the present disclosure, when there is a bullet comment presentation requirement in the virtual space, a location of the user in the virtual space is determined. Then, at least one layer of surrounding bullet comment tracks set in the virtual space is determined with the location of the user as a center, so that various bullet comments can be subsequently presented, to support the user to browse the bullet comments in all directions.

It should be understood that in the present disclosure, the at least one layer of surrounding bullet comment tracks may be explicitly presented in the virtual space, so that the user can intuitively view the at least one layer of surrounding bullet comment tracks in the virtual space. However, considering that the at least one layer of surrounding bullet comment tracks is mainly used to present various bullet comments in the virtual space, the user does not focus on a shape of the tracks, but mainly focuses on the presented bullet comments. Therefore, in the present disclosure, the at least one layer of surrounding bullet comment tracks may also be implicitly presented in the virtual space, without the need for the user to view the at least one layer of surrounding bullet comment tracks intuitively, to present an effect that the bullet comment is suspended in the virtual space for presentation, thereby enhancing the diversity of bullet comment presentation. To facilitate intuitive understanding of the style of the at least one layer of surrounding bullet comment tracks, as shown in FIG. 2, the present disclosure visually displays the at least one layer of surrounding bullet comment tracks in an explicit presentation manner, to visually describe the at least one layer of surrounding bullet comment tracks.

S120: In response to any current bullet comment obtained in the virtual space, determine a presentation position of the current bullet comment in the at least one layer of surrounding bullet comment tracks, and present the current bullet comment at the presentation position.

After the bullet comment function is enabled in the virtual space, the virtual space acquires, in real time, bullet comments sent by each user. Then, to ensure that the bullet comment in the at least one layer of surrounding bullet comment tracks is presented in an ordered manner, when detecting any current bullet comment obtained in the virtual space, the present disclosure may directly determine the presentation position of the current bullet comment in the at least one layer of surrounding bullet comment tracks at a blank position in the at least one layer of surrounding bullet comment tracks, to present the current bullet comment at the presentation position.

As an optional implementation in the present disclosure, to prevent the bullet comments in the at least one layer of surrounding bullet comment tracks from overlapping, the present disclosure determines the presentation position of the current bullet comment in the at least one layer of surrounding bullet comment tracks based on bullet comments that have been presented in the at least one layer of surrounding bullet comment tracks.

In other words, a location of each bullet comment that has been presented in the at least one layer of surrounding bullet comment tracks is first determined. Then, in a blank track area other than the location of each bullet comment that has been presented in the at least one layer of surrounding bullet comment tracks, the presentation position of the current bullet comment in the at least one layer of surrounding bullet comment tracks is randomly determined based on a bullet comment presentation length of the current bullet comment and a requirement that the bullet comments do not overlap as much as possible. Furthermore, the current bullet comment is presented at the presentation position, thereby avoiding, as much as possible, the current bullet comment from overlapping with other bullet comments that have been presented in the at least one layer of surrounding bullet comment tracks, and ensuring the effectiveness of bullet comment presentation in the virtual space.

It should be understood that when presenting any current bullet comment in the at least one layer of surrounding bullet comment tracks, to ensure the diversity of bullet comment presentation, the present disclosure may also adaptively adjust a character presentation style of the current bullet comment, and is not limited to presenting the bullet comment in one character style. For example, various character styles such as a font, a font style, a character color, and a font size of any current bullet comment may be adaptively adjusted. The font size of any current bullet comment needs to adapt to a height of a track where the current bullet comment is located, to avoid a situation in which the current bullet comment exceeds a range of the track due to an excessive font size of the current bullet comment, resulting in an overlap between the current bullet comment and a bullet comment of another track.

In other words, character presentation styles of different bullet comments presented in the at least one layer of surrounding bullet comment tracks may be the same or different. This is not limited in the present disclosure.

According to the technical solution provided in the embodiments of the present disclosure, if a bullet comment enabling instruction is received in the virtual space, at least one layer of surrounding bullet comment tracks in the virtual space is first determined. Then, for any current bullet comment obtained in the virtual space, a presentation position of the current bullet comment in the at least one layer of surrounding bullet comment tracks is determined based on a bullet comment that has been presented in the at least one layer of surrounding bullet comment tracks, to present the current bullet comment at the presentation position, thereby achieving bullet comment surrounding presentation in the virtual space, facilitating a user to browse bullet comments in all directions in the virtual space, and enhancing the diversity and interactive interest of bullet comment presentation in the virtual space, and improving the all-round immersive experience of the user in the virtual space.

As an optional implementation in the present disclosure, to enable the user to browse various bullet comments presented in the at least one layer of surrounding bullet comment tracks as comfortably as possible, and avoid the user from frequently raising or lowering the head to browse the bullet comments, the present disclosure sets a location of the at least one layer of surrounding bullet comment tracks in the virtual space, to ensure the comfort of the user browsing the bullet comments in the virtual space.

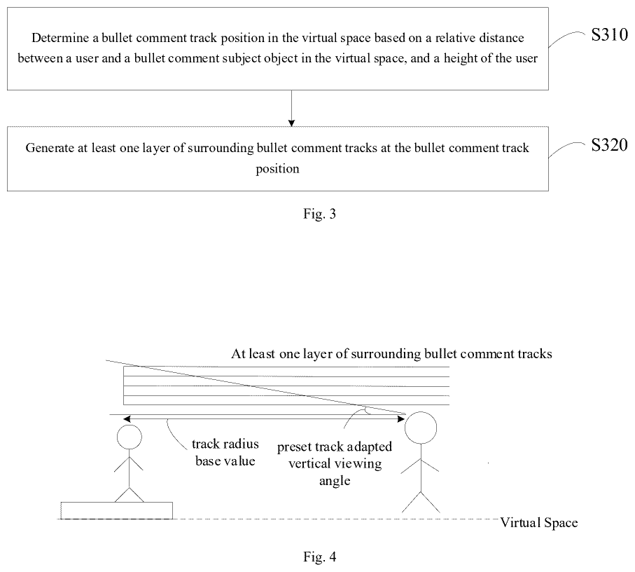

Next, a specific determination process of the at least one layer of surrounding bullet comment tracks in the virtual space is described. As shown in FIG. 3, the process of determining the at least one layer of surrounding bullet comment tracks in the virtual space in the present disclosure may include the following steps:

S310: Determine a bullet comment track position in the virtual space based on a relative distance between a user and a bullet comment subject object in the virtual space, and a height of the user.

Considering that various bullet comments sent by the user in the virtual space are all comment interactions for a specific subject object set in the virtual space and presented as main scene content. For example, in a virtual space corresponding to a specific concert scene, a corresponding main stage and audience seats are set, so that each user can watch performance content on the main stage at the audience seats, and send various bullet comments to the virtual space to evaluate the performance content on the main stage.

Therefore, to ensure that the user in the virtual space browses scene content and various bullet comments in the virtual space synchronously, and avoid the problem that the user needs to frequently rotate the head when browsing the scene content and the bullet comment in the virtual space respectively, the present disclosure may set corresponding at least one layer of surrounding bullet comment tracks above the scene content according to a browsing sight distance between the user and the scene content displayed in the virtual space, so that the bullet comment in the at least one layer of surrounding bullet comment tracks that is in front of the sight of the user and the scene content displayed in the virtual space can be kept in a same vertical plane facing the user.

In the present disclosure, for a location of the scene content displayed in the virtual space, the present disclosure may represent the location by using a location of a virtual object used for presenting the scene content in the virtual space, and use the virtual object as a bullet comment subject object in the present disclosure. For example, in a virtual space corresponding to a specific concert scene, a performer on a main stage may be used as the bullet comment subject object in the present disclosure, and the location of the performer represents a location of performance content watched by the user in the virtual space.

Then, in response to the bullet comment enabling instruction in the virtual space, a location of the bullet comment subject object in the virtual space and a location of the user in the virtual space are first determined. Then, a relative distance between the user and the bullet comment subject object is determined based on the locations of the user and the bullet comment subject object in the virtual space, and used as a surrounding distance between the at least one layer of surrounding bullet comment tracks and the user.

In addition, to avoid the situation that the user frequently raises or lowers the head to browse the bullet comment, considering that the user can visually browse the bullet comment within a vertical field of view in a sight horizontal direction without raising or lowering the head, the present disclosure further determines a corresponding height of the user. A vertical location of the at least one layer of surrounding bullet comment tracks may be determined from a vertical field of view emitted from the height of the user and the relative distance between the user and the bullet comment subject object.

Therefore, the surrounding distance between the at least one layer of surrounding bullet comment tracks and the user and the vertical location of the at least one layer of surrounding bullet comment tracks may form a bullet comment track position of the at least one layer of surrounding bullet comment tracks in the virtual space.

As an optional implementation in the present disclosure, the bullet comment track position of the at least one layer of surrounding bullet comment tracks in the virtual space may include a track radius base value and a track height from ground base value when a location of the user in the virtual space is used as a track center. The track radius base value may be the surrounding distance between the at least one layer of surrounding bullet comment tracks and the user, and represents a radius of a layer of tracks closest to the user in the at least one layer of surrounding bullet comment tracks. The track height from ground base value may be the vertical location of the at least one layer of surrounding bullet comment tracks, and represents a height from the ground of a bottommost layer of tracks in the at least one layer of surrounding bullet comment tracks.

In other words, an actual track radius of each layer of surrounding bullet comment tracks in the at least one layer of surrounding bullet comment tracks when the location of the user is used as a center may be adaptively increased based on the track radius base value, so that each layer of surrounding bullet comment tracks may have a different track radius, and the at least one layer of surrounding bullet comment tracks is presented as an effect that each layer of surrounding bullet comment tracks is continuously enlarged according to a specific rule.

S320: Generate at least one layer of surrounding bullet comment tracks at the bullet comment track position.

After the bullet comment track position in the virtual space is determined, the corresponding at least one layer of surrounding bullet comment tracks may be directly generated at the bullet comment track position according to a preset number of track layers.

As an optional implementation in the present disclosure, a specific generation process of the at least one layer of surrounding bullet comment tracks may be implemented by the following steps:

Step 1: Determine a corresponding single-layer track height based on the track radius base value, a preset track adapted vertical viewing angle and a number of track layers.

To ensure the comfort of the user browsing the bullet comments in the virtual space, an adapted vertical viewing angle may be set for the at least one layer of surrounding bullet comment tracks within a vertical field of view of the user, to ensure that the user can browse the at least one layer of surrounding bullet comment tracks in front of the sight of the user completely by rotating the eyeballs. For example, the track adapted vertical viewing angle in the present disclosure may be set to an elevation angle of 25 degrees above a sight horizontal direction of the user.

Furthermore, as shown in FIG. 4, within a range of the preset track adapted vertical viewing angle, an overall height of the at least one layer of surrounding bullet comment tracks may be determined based on the track radius base value. Then, the overall height is allocated to each layer of surrounding bullet comment tracks according to the preset number of track layers to obtain the corresponding single-layer track height.

It should be noted that the single-layer track height of each layer of surrounding bullet comment tracks in the present disclosure may be the same or different, and is adaptively adjusted according to a bullet comment presentation requirement. This is not limited in the present disclosure.

In addition, as shown in FIG. 4, because the preset track adapted vertical viewing angle is fixed, the overall height of the at least one layer of surrounding bullet comment tracks changes with the track radius base value, and the single-layer track height also changes accordingly. For example, the overall height of the at least one layer of surrounding bullet comment tracks becomes smaller with the reduction of the track radius base value, and the single-layer track height also becomes smaller accordingly.

Step 2: Determine a target height from ground of each layer of surrounding bullet comment tracks based on the track height from ground base value and the single-layer track height.

After the single-layer track height of each layer of surrounding bullet comment tracks is determined, a target height from ground of each layer of surrounding bullet comment tracks may be determined based on the height from the ground of the bottommost layer of tracks represented by the track height from ground base value.

Step 3: Generate the at least one layer of surrounding bullet comment tracks based on the track radius base value and the target height from ground of each layer of surrounding bullet comment tracks.

An actual track radius of each layer of surrounding bullet comment tracks may be adaptively determined based on the track radius base value when the location of the user in the virtual space is used as the track center. Then, each layer of surrounding bullet comment tracks may be generated in the virtual space based on the actual track radius and the target height from ground of each layer of surrounding bullet comment tracks, to obtain the at least one layer of surrounding bullet comment tracks.

According to the technical solution provided in the embodiments of the present disclosure, the bullet comment track position in the virtual space is determined based on the relative distance between the user and the bullet comment subject object in the virtual space, and the height of the user, ensuring the accurate generation of the at least one layer of surrounding bullet comment tracks in the virtual space. In addition, the track radius of each layer of surrounding bullet comment tracks is adaptively adjusted, ensuring the diversity of the at least one layer of surrounding bullet comment tracks.

As an optional implementation in the present disclosure, to ensure the diversity of the bullet comment presentation in the at least one layer of surrounding bullet comment tracks, the present disclosure may set that any bullet comment may be presented in a rolling manner in the at least one layer of surrounding bullet comment tracks, and the bullet comment presentation is cancelled after the bullet comment rolls for a period of distance, thereby avoiding the long-term occupation of the bullet comment that has been presented in the at least one layer of surrounding bullet comment tracks.

For any current bullet comment obtained in the virtual space, when the current bullet comment is presented in a rolling manner in the at least one layer of surrounding bullet comment tracks, to ensure the readability of the bullet comment, the present disclosure may set a bullet comment presentation direction (that is, a bullet comment rolling direction) in the at least one layer of surrounding bullet comment tracks to a counterclockwise direction, so that after any bullet comment that has been presented appears from a position of the at least one layer of surrounding bullet comment tracks, may roll in the counterclockwise direction, thereby maintaining the user's reading habit from left to right. Alternatively, the bullet comment presentation direction (that is, the bullet comment rolling direction) in the at least one layer of surrounding bullet comment tracks may be set to a clockwise direction, so that after any bullet comment that has been presented appears from a position of the at least one layer of surrounding bullet comment tracks, may roll in the clockwise direction.

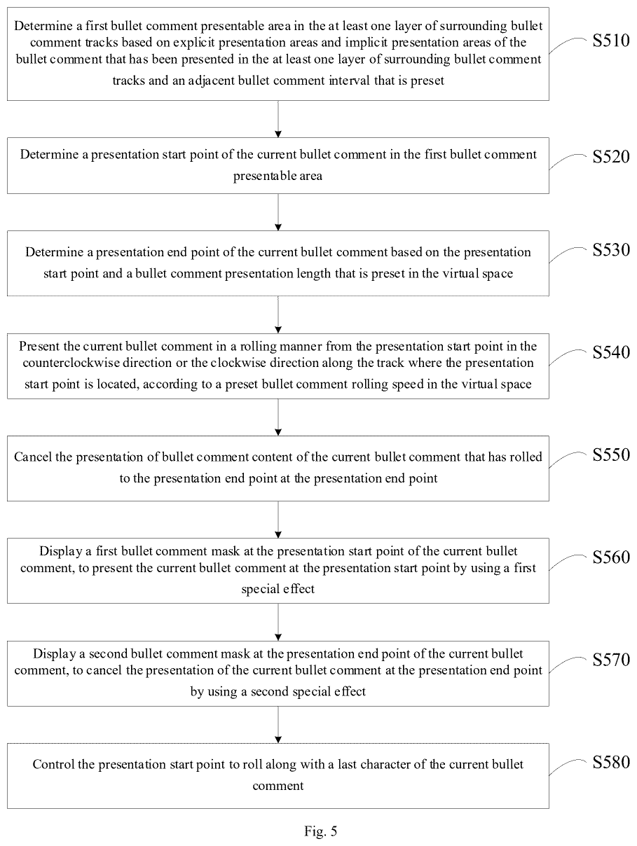

Next, a specific presentation process of any current bullet comment obtained in the virtual space in the at least one layer of surrounding bullet comment tracks is described. As shown in FIG. 5, the specific presentation process of any current bullet comment in the at least one layer of surrounding bullet comment tracks in the present disclosure may include the following steps:

S510: Determine a first bullet comment presentable area in the at least one layer of surrounding bullet comment tracks based on explicit presentation areas and implicit presentation areas of the bullet comment that has been presented in the at least one layer of surrounding bullet comment tracks and an adjacent bullet comment interval that is preset.

When any bullet comment is presented in a rolling manner in the at least one layer of surrounding bullet comment tracks, all content of the bullet comment is not presented at the beginning, but individual characters in the bullet comment are controlled to appear in a rolling manner from a specific position point in the at least one layer of surrounding bullet comment tracks. When a first character of the bullet comment rolls to another position, individual characters in the bullet comment are further controlled to disappear.

For each bullet comment that has been presented in the at least one layer of surrounding bullet comment tracks, some bullet comment content of the bullet comment that has been presented may have been presented in the at least one layer of surrounding bullet comment tracks in a rolling manner, and some other bullet comment content may not have been presented in the at least one layer of surrounding bullet comment tracks. Therefore, in the at least one layer of surrounding bullet comment tracks, each bullet comment that has been presented may have a corresponding explicit presentation area and a corresponding implicit presentation area.

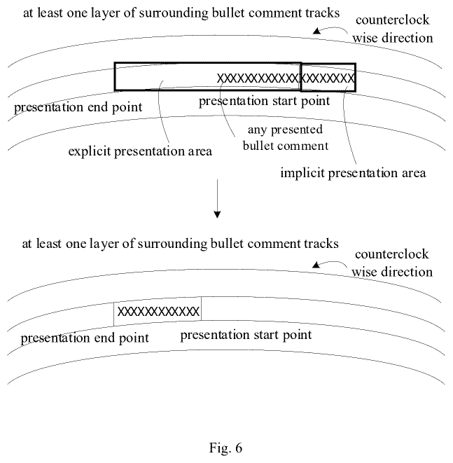

As shown in FIG. 6, the explicit presentation area of each bullet comment that has been presented may be a full presentation area that the bullet comment that has been presented must pass through from the beginning of appearance to disappearance in the at least one layer of surrounding bullet comment tracks. The implicit presentation area of each bullet comment that has been presented may be a partial track area in the at least one layer of surrounding bullet comment tracks where some bullet comment content that has not yet been presented in the at least one layer of surrounding bullet comment tracks in the bullet comment that has been presented is hidden, which may avoid an overlap between some bullet comment content that has not yet been presented in the bullet comment that has been presented and a new bullet comment that appears after each bullet comment that has been presented.

In the present disclosure, upon receiving any current bullet comment obtained in the virtual space, each bullet comment that has been presented in the at least one layer of surrounding bullet comment tracks is first determined. Then, an explicit presentation area of the bullet comment that has been presented is determined based on a location interval of each bullet comment that has been presented in the at least one layer of surrounding bullet comment tracks from the beginning of presentation to disappearance. In addition, an implicit presentation area of the presented bullet comment is determined based on a location interval of some bullet comment content, in the presented bullet comment, that has not yet been presented (when hidden) in the at least one layer of surrounding bullet comment tracks.

Then, the explicit presentation area and the implicit presentation area of each bullet comment that has been presented are combined to obtain a combined presentation area where each bullet comment that has been presented is located. Then, according to the adjacent bullet comment interval that is preset, a small area corresponding to the adjacent bullet comment interval may be respectively added before and after the combined presentation area where each bullet comment that has been presented is located, to obtain a bullet comment non-presentable area corresponding to each bullet comment that has been presented, so that new bullet comment does not appear in the bullet comment non-presentable area, avoiding the overlap between the bullet comment in the at least one layer of surrounding bullet comment tracks. Furthermore, the bullet comment non-presentable area corresponding to each bullet comment that has been presented is excluded from the at least one layer of surrounding bullet comment tracks to obtain the first bullet comment presentable area in the at least one layer of surrounding bullet comment tracks, so that the current bullet comment can be subsequently presented in the first bullet comment presentable area, and the overlap with the bullet comment that has been presented is avoided.

The adjacent bullet comment interval in the present disclosure may be determined by using a plurality of intervals of characters. For example, two adjacent bullet comment may be spaced by two characters. This is not limited in the present disclosure.

S520: Determine a presentation start point of the current bullet comment in the first bullet comment presentable area.

After the first bullet comment presentable area in the at least one layer of surrounding bullet comment tracks is determined, a position point in the first bullet comment presentable area may be randomly determined as the presentation start point of the current bullet comment, so that the current bullet comment can be subsequently presented in a rolling manner from the presentation start point.

S530: Determine a presentation end point of the current bullet comment based on the presentation start point and a bullet comment presentation length that is preset in the virtual space.

To avoid the long-term presentation occupation of the bullet comment that has been presented in the at least one layer of surrounding bullet comment tracks, resulting in the failure of presentation of the new bullet comment due to the lack of a presentation position, the present disclosure sets the bullet comment presentation length. The bullet comment presentation length may be a track length that any bullet comment passes through from the beginning of presentation to disappearance in the at least one layer of surrounding bullet comment tracks.

As an optional implementation in the present disclosure, to ensure efficient browsing of the bullet comment that has been presented in the at least one layer of surrounding bullet comment tracks by the user, based on a lateral field of the user in the virtual space, a target track arc length of the at least one layer of surrounding bullet comment tracks within a lateral field of view of the user may be determined. Then, the target track arc length is used as the bullet comment presentation length in the present disclosure. When the bullet comment presentation direction is the counterclockwise direction, it can be ensured that a specific bullet comment starts to be presented from the right field of view of the user and rolls in the counterclockwise direction along the track where the bullet comment is located, and can pass through the entire lateral field of view of the user in the virtual space, and then disappears from the left field of view of the user, so that the bullet comment is completely presented in front of the sight of the user, improving the effectiveness of bullet comment presentation in the virtual space. Therefore, the bullet comment presentation length that is preset in the virtual space in the present disclosure is positively correlated with the lateral field of view of the user in the virtual space.

After the presentation start point of the current bullet comment is determined, a position point on the track where the presentation start point is located and spaced apart from the presentation start point by the bullet comment presentation length may be determined as the presentation end point of the current bullet comment.

The presentation end point may be a position point spaced apart from the presentation start point by the bullet comment presentation length that is preset in the counterclockwise direction or the clockwise direction along the track where the presentation start point is located.

S540: Present the current bullet comment in a rolling manner from the presentation start point in the counterclockwise direction or the clockwise direction along the track where the presentation start point is located, according to a preset bullet comment rolling speed in the virtual space.

To ensure the regularity of the rolling presentation of the bullet comment that has been presented in the at least one layer of surrounding bullet comment tracks, the present disclosure may preset a bullet comment rolling speed, so that each bullet comment that has been presented in the at least one layer of surrounding bullet comment tracks can maintain a same rolling rate, avoiding the overlap between the bullet comments.

As an optional implementation in the present disclosure, considering that different types of virtual spaces have different degrees of interaction, a quantity of bullet comments that can be presented in different virtual spaces is also different. Therefore, to ensure the suitability of bullet comment presentation in the virtual space, the present disclosure may determine the bullet comment rolling speed in the virtual space according to the type of the virtual space. For example, for a virtual space with a high degree of interaction, such as a virtual shopping room, there is a large demand for bullet comments, so the bullet comment rolling speed in the virtual space may be set to a large value, so that the bullet comments roll faster to present more bullet comments. For a virtual space with a low degree of interaction, such as a virtual reading club, there is a small demand for bullet comments, so the bullet comment rolling speed in the virtual space may be set to a small value, so that the bullet comments roll slower, allowing the user to read each bullet comment more accurately.

After the presentation start point of the current bullet comment is determined, a bullet comment content of the current bullet comment appears from the presentation start point continuously according to the preset bullet comment rolling speed in the virtual space. In addition, a part of the bullet comment content that has been presented in the current bullet comment is controlled to roll to the presentation end point of the current bullet comment in the counterclockwise direction or the clockwise direction along the track where the presentation start point is located, thereby completing the rolling presentation of the current bullet comment from the presentation start point to the presentation end point.

S550: Cancel the presentation of bullet comment content of the current bullet comment that has rolled to the presentation end point at the presentation end point.

After the first character of the current bullet comment rolls to the presentation end point of the current bullet comment, the presentation of character content of the current bullet comment that has rolled to the presentation end point is continuously cancelled at the presentation end point, thereby completing the rolling presentation of the current bullet comment for a bullet comment presentation length that is preset, and avoiding the long-term occupation of the at least one layer of surrounding bullet comment tracks.

S560: Display a first bullet comment mask at the presentation start point of the current bullet comment, to present the current bullet comment at the presentation start point by using a first special effect.

To avoid the interruption of the user's reading of the bullet comment due to the sudden appearance of any bullet comment in the at least one layer of surrounding bullet comment tracks at the presentation start point, the present disclosure displays the first bullet comment mask at the presentation start point of the current bullet comment. The first bullet comment mask may set a pixel transparency of the presentation start point to a highest value (for example, completely transparent), and then continuously reduces the pixel transparency in the counterclockwise direction along the track until the pixel transparency is reduced to a lowest value (for example, completely opaque) after a mask width of the first bullet comment mask is completed. For example, the mask width of the first bullet comment mask may be a width of one character. This is not limited in the present disclosure.

After the first bullet comment mask is displayed at the presentation start point of the current bullet comment, each character that appears in a rolling manner at the presentation start point may gradually change from completely transparent to completely opaque, and the current bullet comment is presented at the presentation start point using the first special effect, to prompt the user in advance that the current bullet comment starts to be presented. The first special effect may be a fade-in special effect.

S570: Display a second bullet comment mask at the presentation end point of the current bullet comment, to cancel the presentation of the current bullet comment at the presentation end point by using a second special effect.

To avoid the interruption of the user's reading of the bullet comment due to the sudden disappearance of any bullet comment in the at least one layer of surrounding bullet comment tracks at the presentation end point, the present disclosure displays the second bullet comment mask at the presentation end point of the current bullet comment. The second bullet comment mask may set a pixel transparency of a position point spaced apart from the presentation end point by a mask width of the second bullet comment mask to a lowest value (for example, completely opaque), and then continuously increases the pixel transparency in the counterclockwise direction or the clockwise direction along the track until the pixel transparency is increased to a highest value (for example, completely transparent) after reaching the presentation end point. For example, the mask width of the second bullet comment mask may be a width of five characters. This is not limited in the present disclosure.

After the second bullet comment mask is displayed at the presentation end point of the current bullet comment, each character that rolls from a position point corresponding to the mask width of the second bullet comment mask to the presentation end point in the counterclockwise direction or the clockwise direction along the track may gradually change from completely opaque to completely transparent, and the presentation of the current bullet comment is cancelled at the presentation end point using a fade-out special effect, to prompt the user in advance that the current bullet comment starts to disappear.

S580: Control the presentation start point to roll along with a last character of the current bullet comment.

After the last character of the current bullet comment, that is, the last character in the present disclosure, is presented at the presentation start point of the current bullet comment, no new characters are presented. Therefore, to avoid the extra occupation of the current bullet comment in the at least one layer of surrounding bullet comment tracks, as shown in FIG. 6, the present disclosure controls the presentation start point of the current bullet comment to roll along with the last character of the current bullet comment, so that the non-presentable area of the bullet comment represented between the presentation start point and the presentation end point is continuously reduced as the current bullet comment rolls, leaving a corresponding presentable area of the bullet comment for a new bullet comment.

According to the technical solution provided in the embodiments of the present disclosure, the first bullet comment presentable area in the at least one layer of surrounding bullet comment tracks is determined based on the explicit presentation area and the implicit presentation area of the bullet comment that has been presented in the at least one layer of surrounding bullet comment tracks and the adjacent bullet comment interval that is preset, to determine the presentation start point and the presentation end point of the current bullet comment, avoiding the overlap between the bullet comment in the at least one layer of surrounding bullet comment tracks. In addition, a corresponding bullet comment mask is displayed at the presentation start point and the presentation end point of the current bullet comment, to present the current bullet comment using the first special effect, and cancel the presentation of the current bullet comment using the second special effect, enhancing the interactive diversity of bullet comment presentation in the virtual space.

According to one or more embodiments of the present disclosure, considering that there may be bullet comments from different sending objects in the virtual space, for example, a bullet comment sent by the user, a bullet comment sent by other users, or ambient bullet comment in the virtual space. In the virtual space, the user has different reading requirements for the bullet comment from the different sending objects. The bullet comment with a high reading requirement is presented in front of the sight of the user as much as possible, while the bullet comment with a low reading requirement such as the ambient bullet comment is presented behind the user. Therefore, the present disclosure may define a plurality of bullet comment production areas in the at least one layer of surrounding bullet comment tracks, and set different bullet comment production weights for different bullet comment production areas, to start to present different types of bullet comments in different bullet comment production areas.

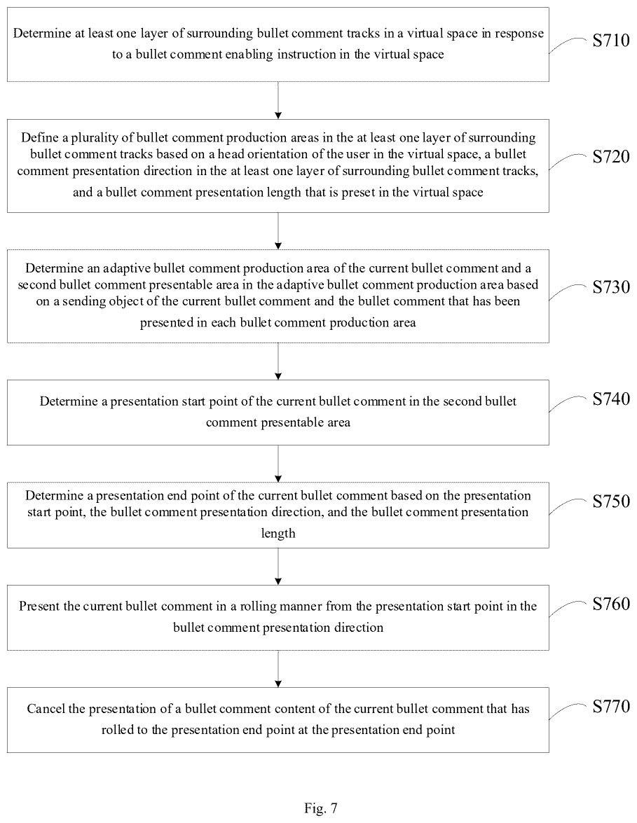

Next, the specific presentation process of the current bullet comment in the at least one layer of surrounding bullet comment tracks is described based on the plurality of bullet comment production areas delimited in the at least one layer of surrounding bullet comment tracks. As shown in FIG. 7, the method may include the following steps:

S710: Determine at least one layer of surrounding bullet comment tracks in a virtual space in response to a bullet comment enabling instruction in the virtual space.

S720: Define a plurality of bullet comment production areas in the at least one layer of surrounding bullet comment tracks based on a head orientation of the user in the virtual space, a bullet comment presentation direction in the at least one layer of surrounding bullet comment tracks, and a bullet comment presentation length that is preset in the virtual space.

To present some bullet comments that the user focuses on in a track interval of the at least one layer of surrounding bullet comment tracks that is within a field of view in front of the sight of the user, the head orientation of the user in the virtual space needs to be focused on first, so as to determine the track interval of the at least one layer of surrounding bullet comment tracks that is within the field of view in front of the sight of the user.

In addition, taking that the bullet comment presentation direction in the at least one layer of surrounding bullet comment tracks is a counterclockwise direction along the track as an example, the bullet comment usually needs to start to be presented from the at least one layer of surrounding bullet comment tracks located at the right front of the user, so as to be presented in a rolling manner in front of the sight of the user, so that the user can read the bullet comment accurately. Therefore, the present disclosure may set that a partial area of the at least one layer of surrounding bullet comment tracks located at the right front of the user needs to frequently generate corresponding bullet comments, so that a large quantity of bullet comments can be presented in a rolling manner in front of the sight of the user.

Whether the bullet comment presented in the partial area of the at least one layer of surrounding bullet comment tracks located at the right front of the user can roll in front of the sight of the user needs to be determined with the aid of the bullet comment presentation length that is preset in the virtual space. The bullet comment presentation length that is preset in the virtual space in the present disclosure is positively correlated with the lateral field of view of the user in the virtual space.

It can be seen from the foregoing content that to achieve the readability of the bullet comment in the at least one layer of surrounding bullet comment tracks, and make the bullet comment that has been presented in the at least one layer of surrounding bullet comment tracks roll in front of the sight of the user as much as possible, the present disclosure may divide, based on the head orientation of the user in the virtual space, a track area of the at least one layer of surrounding bullet comment tracks that is within a range right in front of the user into a bullet comment production area with an extremely low weight, so that the bullet comment production area starts to present bullet comment as little as possible, and almost all presents the bullet comment that rolls from other bullet comment production areas.

When the bullet comment presentation direction in the at least one layer of surrounding bullet comment tracks is the counterclockwise direction along the track, a sight center point of the user that is right in front of the at least one layer of surrounding bullet comment tracks may be determined. Then, in the clockwise direction along the track, a partial track area where a position point is located and that has a preset track length (for example, an arc length corresponding to 40 degrees) is divided at a position point spaced apart from the sight center point by a half value of the bullet comment presentation length, to obtain a bullet comment production area with a highest weight, so that the bullet comment production area starts to present bullet comment as much as possible, and almost all the bullet comments that have been presented can roll in front of the sight of the user for presentation.

A bullet comment production area with a weight lower than the highest weight and higher than the extremely low weight may be respectively delimited on the left and right sides of the bullet comment production area with the highest weight in the at least one layer of surrounding bullet comment tracks. In addition, a remaining track area may be delimited as a bullet comment production area with a weight only higher than the extremely low weight and lower than the other weights. The bullet comment production area may start to present some bullet comments that the user does not pay much attention to, such as ambient bullet comments and prefabricated bullet comments.

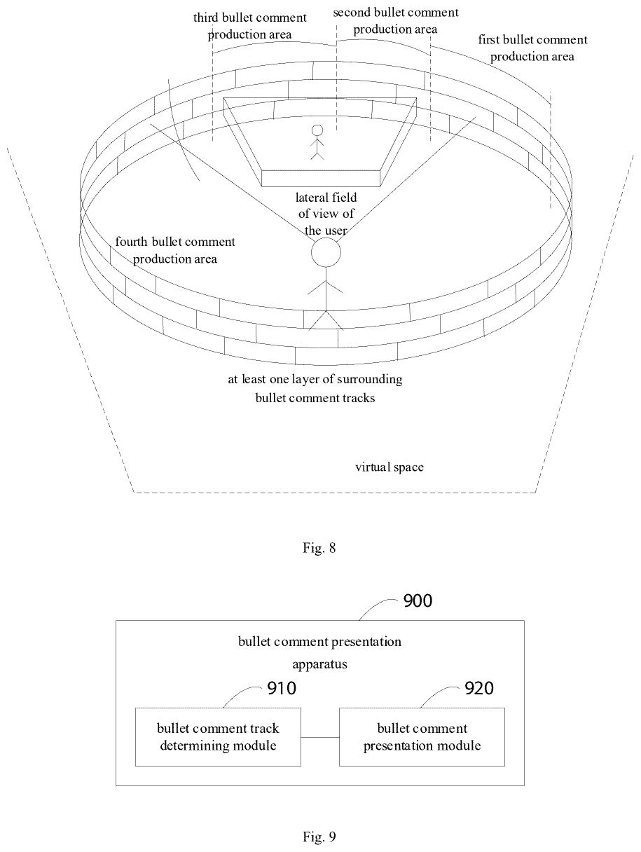

For example, as shown in FIG. 8, taking the bullet comment presentation direction as the counterclockwise direction along the track as an example, the bullet comment presentation length that is preset in the virtual space is positively correlated with the lateral field of view of the user. Therefore, taking the lateral field of view of the user as 87 degrees as an example, a first bullet comment production area with a high weight corresponding to an arc length of 30 degrees may be delimited outside the rightmost side of the lateral field of view of the user. Then, a second bullet comment production area with a medium weight corresponding to an arc length of 30 degrees is delimited next to the first bullet comment production area with the high weight in the counterclockwise direction along the track. Then, a third bullet comment production area with an extremely low weight corresponding to an arc length of 40 degrees is delimited next to the second bullet comment production area with the medium weight in the counterclockwise direction along the track. Then, a remaining area in the at least one layer of surrounding bullet comment tracks may be delimited as a fourth bullet comment production area with a low weight.

In addition, considering that the user's head in the virtual space may rotate accordingly, resulting in a change in the head orientation of the user. Therefore, the present disclosure may update the plurality of bullet comment production areas delimited in the at least one layer of surrounding bullet comment tracks in response to a rotation operation of the user's head.

In other words, upon detecting the rotation operation of the user's head, the plurality of bullet comment production areas delimited in the at least one layer of surrounding bullet comment tracks needs to be updated, so that most of the bullet comments that have been presented in the at least one layer of surrounding bullet comment tracks can still be presented in front of the sight of the user.

As an optional implementation in the present disclosure, to ensure the stability of bullet comment presentation in the plurality of bullet comment production areas delimited in the at least one layer of surrounding bullet comment tracks, the present disclosure does not update the plurality of bullet comment production areas delimited in the at least one layer of surrounding bullet comment tracks in real time, but sets a time delay. After the user's head rotates for the preset time delay, the plurality of bullet comment production areas delimited in the at least one layer of surrounding bullet comment tracks are updated based on the rotated head orientation of the user, the bullet comment presentation direction in the at least one layer of surrounding bullet comment tracks, and the bullet comment presentation length that is preset, ensuring the stability of the plurality of bullet comment production areas.

S730: Determine an adaptive bullet comment production area of the current bullet comment and a second bullet comment presentable area in the adaptive bullet comment production area based on a sending object of the current bullet comment and the bullet comment that has been presented in each bullet comment production area.

For any current bullet comment obtained in the virtual space, a sending object of the current bullet comment is first determined. The bullet comment from different sending objects receive different degrees of attention from the user, and thus the presentation positions in the at least one layer of surrounding bullet comment tracks are also different. Therefore, the bullet comment from different sending objects needs to be adapted to different bullet comment production areas, to be presented in a rolling manner at different positions in the at least one layer of surrounding bullet comment tracks.

For example, the bullet comment sent by the user has a high degree of attention, and thus needs to be adapted to a bullet comment production area with a high weight, so that the bullet comment can be presented in a rolling manner in front of the sight of the user. For ambient bullet comments and prefabricated bullet comments in the virtual space, the user has a low degree of attention, and thus needs to be adapted to a bullet comment production area with a low weight, so that the bullet comments are presented in a rolling manner on the left side or behind the sight of the user.

In addition, if there are too many bullet comments that have been presented in a specific bullet comment production area, and the specific bullet comment production area is no longer suitable for presenting the current bullet comment, the adaptive bullet comment production area of the current bullet comment needs to be adjusted to the next weight.

Therefore, one bullet comment production area that is most adaptive to the current bullet comment is determined based on the sending object of the current bullet comment. Then, whether there is an unoccupied bullet comment presentable area in the bullet comment production area is determined based on the explicit presentation area and the implicit presentation area of each bullet comment that has been presented in the bullet comment production area and the adjacent bullet comment interval that is preset. If there is an unoccupied bullet comment presentable area, the bullet comment production area is used as the adaptive bullet comment production area of the current bullet comment.

If there is no unoccupied bullet comment presentable area in the bullet comment production area, whether there is an unoccupied bullet comment presentable area in the bullet comment production area with the next weight is further determined. If there is an unoccupied bullet comment presentable area, the bullet comment production area with the next weight is used as the adaptive bullet comment production area of the current bullet comment.

Then, the second bullet comment presentable area in the adaptive bullet comment production area may be determined based on the explicit presentation area and the implicit presentation area of each bullet comment that has been presented in the adaptive bullet comment production area and the adjacent bullet comment interval that is preset.

S740: Determine a presentation start point of the current bullet comment in the second bullet comment presentable area.

After the second bullet comment presentable area in the adaptive bullet comment production area of the current bullet comment is determined, a position point in the second bullet comment presentable area may be randomly determined as the presentation start point of the current bullet comment, so that the current bullet comment can be subsequently presented in a rolling manner from the presentation start point.

S750: Determine a presentation end point of the current bullet comment based on the presentation start point, the bullet comment presentation direction, and the bullet comment presentation length.

After the presentation start point of the current bullet comment is determined, a position point on the track where the presentation start point is located and spaced apart from the presentation start point by the bullet comment presentation length in the bullet comment presentation direction may be determined as the presentation end point of the current bullet comment.

S760: Present the current bullet comment in a rolling manner from the presentation start point in the bullet comment presentation direction.

After the presentation start point of the current bullet comment is determined, a bullet comment content of the current bullet comment appears from the presentation start point continuously. In addition, a part of the bullet comment content that has been presented in the current bullet comment is controlled to roll to the presentation end point of the current bullet comment in the counterclockwise direction or the clockwise direction along the track where the presentation start point is located, thereby completing the rolling presentation of the current bullet comment from the presentation start point to the presentation end point.

S770: Cancel the presentation of a bullet comment content of the current bullet comment that has rolled to the presentation end point at the presentation end point.

After the first character of the current bullet comment rolls to the presentation end point of the current bullet comment, the presentation of character content of the current bullet comment that has rolled to the presentation end point is continuously cancelled at the presentation end point, thereby completing the rolling presentation of the current bullet comment for a bullet comment presentation length that is preset, and avoiding the long-term occupation of the at least one layer of surrounding bullet comment tracks.

According to the technical solution provided in the embodiments of the present disclosure, the plurality of bullet comment production areas are delimited in the at least one layer of surrounding bullet comment tracks, and the presentation start point and the presentation end point of the current bullet comment are determined based on the second bullet comment presentable area in the adaptive bullet comment production area of the current bullet comment, so that most of the bullet comments are presented in front of the sight of the user as much as possible, ensuring the readability of the bullet comment in the virtual space.

FIG. 9 is a schematic diagram of a bullet comment presentation apparatus according to an embodiment of the present disclosure. The bullet comment presentation apparatus 900 may be configured in an XR device. The bullet comment presentation apparatus 900 may include:

a bullet comment track determining module 910, configured to determine at least one layer of surrounding bullet comment tracks in a virtual space in response to a bullet comment enabling instruction in the virtual space; and

a bullet comment presentation module 920, configured to determine, in response to any current bullet comment obtained in the virtual space, a presentation position of the current bullet comment in the at least one layer of surrounding bullet comment tracks based on a bullet comment that has been presented in the at least one layer of surrounding bullet comment tracks, to present the current bullet comment at the presentation position.

In some implementations, the bullet comment track determining module 910 may include:
a track location determining unit, configured to determine a bullet comment track position in the virtual space based on a relative distance between a user and a bullet comment subject object in the virtual space, and a height of the user; and
a bullet comment track generating unit, configured to generate at least one layer of surrounding bullet comment tracks at the bullet comment track position.

In some implementations, the bullet comment track position includes a track radius base value and a track height from ground base value when a location of the user in the virtual space is used as a track center.

In some implementations, the bullet comment track generating unit may be specifically configured to:
determine a corresponding single-layer track height based on the track radius base value and a preset track adapted vertical viewing angle and number of track layers;
determine a target height from ground of each layer of surrounding bullet comment tracks based on the track height from ground base value and the single-layer track height; and
generate the at least one layer of surrounding bullet comment tracks based on the track radius base value and the target height from ground of each layer of surrounding bullet comment tracks.

In some implementations, the bullet comment presentation module 920 may be specifically configured to:
determine a first bullet comment presentable area in the at least one layer of surrounding bullet comment tracks based on an explicit presentation area and an implicit presentation area of the bullet comment that has been presented in the at least one layer of surrounding bullet comment tracks and an adjacent bullet comment interval that is preset;
determine a presentation start point of the current bullet comment in the first bullet comment presentable area; and
determine a presentation end point of the current bullet comment based on the presentation start point and a bullet comment presentation length that is preset in the virtual space.

In some implementations, the presentation end point is a position point spaced apart from the presentation start point by the bullet comment presentation length in the counterclockwise direction or the clockwise direction along the track where the presentation start point is located.

In some implementations, the bullet comment presentation module 920 may be further specifically configured to:
present the current bullet comment in a rolling manner from the presentation start point in the counterclockwise direction or the clockwise direction along the track where the presentation start point is located, according to a preset bullet comment rolling speed in the virtual space; and
cancel the presentation of a bullet comment content of the current bullet comment that has rolled to the presentation end point at the presentation end point.

In some implementations, the bullet comment presentation apparatus 900 may further include a mask display module. The mask display module may be configured to:
display a first bullet comment mask at the presentation start point of the current bullet comment, to present the current bullet comment at the presentation start point using a first special effect; and
display a second bullet comment mask at the presentation end point of the current bullet comment, to cancel the presentation of the current bullet comment at the presentation end point using a second special effect.

In some implementations, the bullet comment presentation apparatus 900 may further include:

a start point following module, configured to control the presentation start point to roll along with a last character of the current bullet comment.

In some implementations, the bullet comment presentation apparatus 900 may further include:

a bullet comment production area defining module, configured to define a plurality of bullet comment production areas in the at least one layer of surrounding bullet comment tracks based on a head orientation of the user in the virtual space, a bullet comment presentation direction in the at least one layer of surrounding bullet comment tracks, and a bullet comment presentation length that is preset in the virtual space, where the bullet comment production areas have different bullet comment production weights.

In some implementations, the bullet comment presentation module 920 may be further specifically configured to:
determine an adaptive bullet comment production area of the current bullet comment and a second bullet comment presentable area in the adaptive bullet comment production area based on a sending object of the current bullet comment and the bullet comment that has been presented in each bullet comment production area;
determine a presentation start point of the current bullet comment in the second bullet comment presentable area;
determine a presentation end point of the current bullet comment based on the presentation start point, the bullet comment presentation direction, and the bullet comment presentation length;
present the current bullet comment in a rolling manner from the presentation start point in the bullet comment presentation direction; and
cancel the presentation of a bullet comment content of the current bullet comment that has rolled to the presentation end point at the presentation end point.

In some implementations, the bullet comment presentation apparatus 900 may further include:

a bullet comment production area updating module, configured to update the plurality of bullet comment production areas delimited in the at least one layer of surrounding bullet comment tracks after a preset time delay in response to a rotation operation of the user's head.

In some implementations, the bullet comment presentation length that is preset in the virtual space is positively correlated with the lateral field of view of the user in the virtual space.

In the embodiments of the present disclosure, if a bullet comment enabling instruction is received in the virtual space, the at least one layer of surrounding bullet comment tracks in the virtual space is first determined. Then, for any current bullet comment obtained in the virtual space, a presentation position of the current bullet comment in the at least one layer of surrounding bullet comment tracks is determined based on the bullet comment that has been presented in the at least one layer of surrounding bullet comment tracks, to present the current bullet comment at the presentation position, thereby achieving the surrounding presentation of the bullet comment in the virtual space, facilitating the user to browse the bullet comments in all directions in the virtual space, enhancing the diversity and interactive interest of bullet comments presentation in the virtual space, and improving the all-round immersive experience of the user in the virtual space.

It should be understood that the apparatus embodiment may correspond to the method embodiment in the present disclosure, and similar descriptions may be made with reference to the method embodiment in the present disclosure. To avoid repetition, details are not described herein again.

Specifically, the apparatus 900 shown in FIG. 9 may perform any method embodiment provided in the present disclosure, and the foregoing and other operations and/or functions of each module in the apparatus 900 shown in FIG. 9 are intended to implement the corresponding processes of the above method embodiment. For the sake of brevity, details are not described herein again.

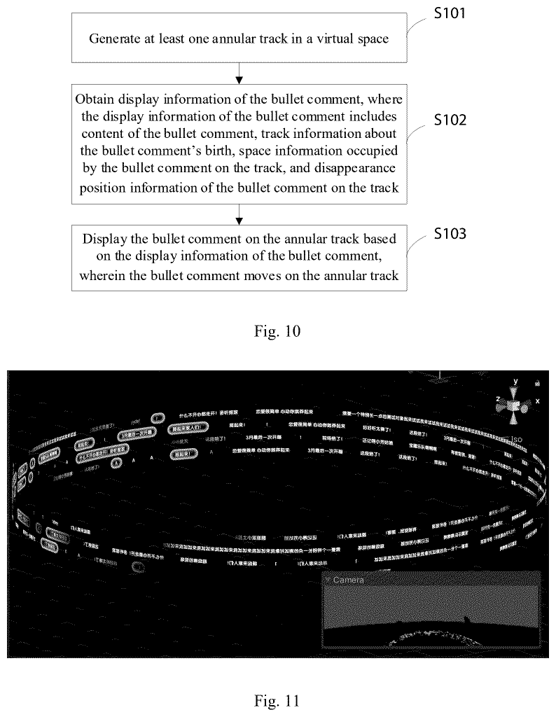

FIG. 10 is a flowchart of a method for displaying a bullet comment according to an embodiment of the present disclosure (Embodiment 1). This embodiment of the present disclosure is applicable to a human-computer interaction scenario. The method for displaying a bullet comment may be performed by an apparatus for displaying a bullet comment. The apparatus may be formed by hardware and/or software, and may be integrated into an electronic device. In this embodiment of the present disclosure, the electronic device is an XR device such as a VR device, an AR device, or an MR device, or may be a device such as a mobile phone or a computer. In this embodiment, the XR device is used as an example for description. As shown in FIG. 10, the method for displaying a bullet comment includes the following steps.

S101: Generate at least one annular track in a virtual space.

The annular track is used to display bullet comments. The bullet comment refers to a comment subtitle superimposed and displayed on a UI of an application. The bullet comment mainly includes text information, and a font color and a font size of the text information may be flexibly configured. Optionally, the bullet comment further includes image information, for example, an expression image. Optionally, the bullet comment further includes an interactive option. The user may perform an interactive operation on the interactive option in the bullet comment to express agreement or disagreement with the bullet comment.

The annular track may be a circular track or an elliptical track, or may be a closed track of another shape. When a plurality of annular tracks are arranged in the virtual space, the plurality of annular tracks are concentric tracks with different radii.

The virtual space may be a 2D space or a 3D extended reality space. When the virtual space is the extended reality space, radii of the plurality of annular tracks may be the same or different. When the radii of the plurality of annular tracks are the same, heights of the plurality of annular tracks in a direction perpendicular to a plane where the radii are located are different, so that the bullet comment on the plurality of tracks can be prevented from being the same. When the radii of the plurality of annular tracks are different, heights of the plurality of annular tracks in the direction perpendicular to the plane where the radii are located may be the same or different. For example, if the plane where the radius of the annular track is located is an xz plane, the direction perpendicular to the plane where the radius is located is a y-axis direction.

A position of the annular track in the virtual space may be a fixed position, or may be flexibly set by the user. The device may provide a default position. If the default position does not meet the requirements of the user, the user may modify the default position.

Taking a circular track as an example, a position of the circular track in the virtual space includes a center coordinate and a radius. A setting entry of the circular track may be provided, and the user opens a setting interface through the setting entry of the circular track to adjust the circular coordinate and/or the radius.

S102: Obtain display information of the bullet comment, where the display information of the bullet comment includes content of the bullet comment, track information about the bullet comment's birth, space information occupied by the bullet comment on the track, and disappearance position information of the bullet comment on the track.

Some applications in the device have a bullet comment function, and the user may choose to enable or disable the bullet comment function. After the user enables the bullet comment function of the application, during the running of the application, the bullet comment is displayed on a user interface (UI) of the application. The application may be an application software, for example, a video application, a game application, a live broadcast application, a music playback application, or the like. These application softwares usually support the bullet comment function. For example, in the video application, during the process of watching a video, the user may comment on and discuss the content of the video. The application may also be a mini program or an application module in a host application, or may be a web platform. This is not limited in the embodiments of the present disclosure.

There are usually a large quantity of bullet comments in the application, and the bullet comments may be distributed on the at least one annular track and move on the annular track, that is, move according to a track of the annular track.

The content of the bullet comment may be composed of one or more of the following information: text, punctuation marks, and emoticons.

The track information about the bullet comment's birth refers to information of a track where the bullet comment is displayed. The track information about the bullet comment's birth is used to determine on which track the bullet comment is displayed. The track information includes an identifier of the track, and optionally, may further include position information of the track, for example, a center position and a radius of the track.

The space information occupied by the bullet comment on the track may be an angle interval occupied by the bullet comment on the track. For example, the angle interval is 10 to 20 degrees, 30 to 45 degrees, and the like. An upper limit of the angle interval is a birth angle of the bullet comment on the track, and a length of the angle interval is a length of the bullet comment. The birth angle of the bullet comment on the track plus the length of the bullet comment may be used to obtain the angle interval occupied by the bullet comment on the track. For example, if the birth angle of the bullet comment is 10 degrees and the length of the bullet comment is 10 degrees, an upper limit of the angle interval occupied by the bullet comment on the track is 10+10=20 degrees, and the angle interval occupied by the bullet comment on the track is 10 to 20 degrees. Therefore, the space information occupied by the bullet comment on the track may also be a birth position of the bullet comment and the length of the bullet comment. The birth position of the bullet comment is the birth angle of the bullet comment on the track.

The disappearance position information of the bullet comment on the track may be a disappearance angle of the bullet comment on the track. For example, if the bullet comment is born at the position of 10 degrees on the track and disappears at the position of 120 degrees, the disappearance angle of the bullet comment on the track is 120 degrees.

In the embodiments of the present disclosure, the bullet comment may be a bullet comment that has been generated or a newly bullet comment that has been generated. The newly bullet comment that has been generated is also referred to as a new bullet comment. The newly bullet comment that has been generated refers to a bullet comment that has not been displayed on the track before the current moment. Correspondingly, the bullet comment that has been generated may be understood as a bullet comment that has been displayed at least once before the current moment.

It may be understood that the bullet comment in the application is usually displayed a plurality of times. After a new bullet comment is generated, the bullet comment is displayed once. According to a preset policy, the bullet comment may be displayed again after a preset duration, or the bullet comment that has been generated is displayed again when the user opens the application next time. Each time the user opens the application, a new bullet comment may be generated or no new bullet comment may be generated, and only the bullet comment that has been generated is displayed.

The information of the bullet comment that has been generated may be stored in a server. The information of the bullet comment that has been generated includes but is not limited to the display information of the bullet comment, and may further include other information of the bullet comment, for example, a generation time of the bullet comment, information of a sending user of the bullet comment, and a displayed quantity of the bullet comment. After the bullet comment function is enabled, the XR device requests the display information of the bullet comment that has been generated from the server, and the server returns the display information of the bullet comment that has been generated to the XR device.

The display information of the new bullet comment needs to be generated in real time and sent to the server for storage. For example, it is necessary to determine a birth track, a birth position, a disappearance position, and the like of the new bullet comment.

The information of the bullet comment may be maintained according to the track, and each track maintains the bullet comment on the track according to an order of the bullet comment from the birth angle.

S103: Display the bullet comment on the annular track based on the display information of the bullet comment, wherein the bullet comment moves on the annular track.

The display information of the bullet comment includes the content of the bullet comment, the track information about the bullet comment's birth, the space information occupied by the bullet comment on the track, and the disappearance position information of the bullet comment on the track. Based on the birth track of the bullet comment and the occupied space information, the bullet comment is controlled to be born at a birth position corresponding to the occupied space information on the birth track, and the bullet comment moves on the annular track after being born. When moving to a disappearance position corresponding to the disappearance position information, the bullet comment disappears. A period from the birth to the disappearance of the bullet comment is a life cycle of the bullet comment.

FIG. 11 is a schematic diagram of the display of the bullet comment on the annular track. As shown in FIG. 11, there are four annular tracks displayed in the extended reality space, and the four annular tracks are concentrically arranged rings with different radii.

Exemplarily, the moving speed of the bullet comment on the annular track may be set in the following several manners.

Manner 1: The moving speeds of the bullet comment on the annular tracks are the same, that is, the bullet comment on the tracks are relatively static.

Optionally, the bullet comment on the annular tracks do not overlap each other. Because the moving speeds of the bullet comment are the same, as long as the birth positions of the two bullet comment do not overlap, the bullet comment will not overlap in the life cycle of the bullet comment.

Manner 2: The moving speeds of the bullet comment on the same annular track are the same, and the moving speeds of the bullet comment on different annular tracks are different.

For example, there are two annular tracks, and the moving speed of the bullet comment on an annular track 1 is greater than that of the bullet comment on an annular track 2.

Manner 3: The moving speeds of the bullet comment on the same annular track are different.

Optionally, the bullet comment on the annular track is divided into a host bullet comment and a guest bullet comment. The host bullet comment is sent by a user of a primary viewing angle, and the guest bullet comment is sent by a user of the non-primary viewing angle.

The user of the primary viewing angle may be understood as a user currently using the application, and the user other than the user currently using the application is the user of the non-primary viewing angle. Taking a video application as an example, if a first user opens the application and enables the bullet comment function, the first user is the user of the primary viewing angle. The bullet comment sent by the first user in a picture seen by the first user is the host bullet comment. There is also a bullet comment sent by other users in the video application, and the bullet comment sent by the other users is the guest bullet comment.

The host bullet comment and the guest bullet comment are displayed differently, so that the user can distinguish which bullet comment is sent by the user and which bullet comment is sent by other users.

The host bullet comment and the guest bullet comment are displayed differently, including but not limited to: highlighting the host bullet comment and displaying the guest bullet comment normally; at least one of a font, a color, and a size of the host bullet comment being different from that of the guest bullet comment; and the host bullet comment having a special effect and the guest bullet comment being displayed normally.

Referring to the bullet comment on the track shown in FIG. 11, a peripheral of the host bullet comment is displayed with a light ring, and the light ring may be understood as a special effect. A peripheral of the guest bullet comment is not displayed with a light ring.

Optionally, the special effect of the host bullet comment may also be a periodic blinking special effect.

Because the annular track is a curved track, when the bullet comment is displayed on the curved track, the bullet comment also needs to be curved. A rendering mesh of a normal image is formed by splicing two triangles, and cannot be curved. Therefore, the rendering mesh needs to be subdivided in the horizontal direction, new mesh data is constructed, and a position of a vertex is modified according to an arc degree to form a curved mesh, so that the bullet comment is curved through the curved mesh.

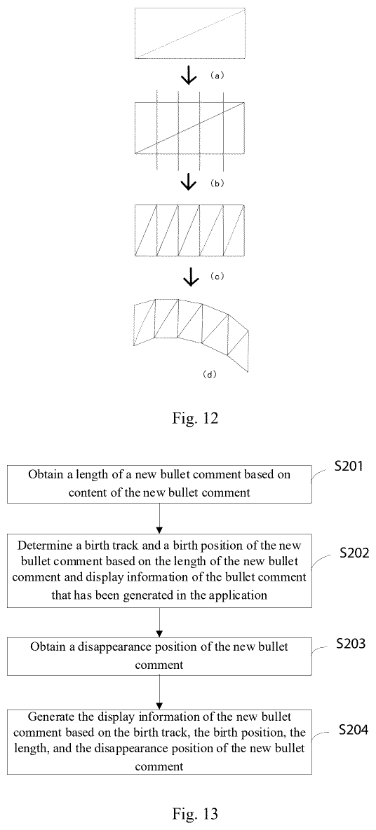

FIG. 12 is a schematic diagram of a bending process of a mesh corresponding to the bullet [0259] comment. As shown in FIG. 12, an image shown in (a) of FIG. 12 is a schematic diagram of a rendering mesh of a normal image, an image shown in (b) of FIG. 12 is a schematic diagram of the rendering mesh of the normal image after being subdivided in the horizontal direction, an image shown in (c) of FIG. 12 is a schematic diagram of a vertex of a new mesh formed after subdivision, and an image shown in (d) of FIG. 12 is a schematic diagram of a curved mesh formed after the vertex of the new mesh is modified according to an arc degree of a birth position of the bullet comment.

Referring to the coordinate system in the image shown in FIG. 11, the coordinate of the vertex is modified, that is, the coordinate of the x-axis and the coordinate of the y-axis are modified, and the coordinate of the z-axis remains unchanged. Correspondingly, the horizontal direction shown in FIG. 12 refers to a direction where an xy plane is located.

In this embodiment, at least one annular track is generated in the virtual space, display information of the bullet comment is obtained, where the display information of the bullet comment includes content of the bullet comment, track information about the bullet comment's birth, space information occupied by the bullet comment on the track, and disappearance position information of the bullet comment on the track; and the bullet comment is displayed on the annular track based on the display information of the bullet comment, and the bullet comment moves on the annular track. The bullet comment is displayed through the annular track, which enriches the display mode of the bullet comment and improves the user experience.

Based on Embodiment 1, Embodiment 2 of the present disclosure provides a method for obtaining display information of a new bullet comment. FIG. 13 is a flowchart of a method for obtaining display information of a new bullet comment according to Embodiment 2 of the present disclosure. As shown in FIG. 13, the method provided in this embodiment includes the following steps.

S201: Obtain a length of a new bullet comment based on content of the new bullet comment.

The content of the new bullet comment is input by the user, and the user may input the content of the new bullet comment through a voice, a keyboard, a gesture, a touch, or the like. The content of the new bullet comment may be composed of one or more of the following information: text, punctuation marks, and emoticons.

The length of the new bullet comment is a size of an angle interval occupied by the new bullet comment on the track. For example, the length of the new bullet comment is 10 degrees or 20 degrees.

S202: Determine a birth track and a birth position of the new bullet comment based on the length of the new bullet comment and display information of the bullet comment that has been generated in the application.

When determining the birth position of the new bullet comment, it is necessary to obtain the display information of the bullet comment that has been generated in the application, and the XR device requests the display information of the bullet comment that has been generated from the server. The display information of the bullet comment that has been generated includes the content of the bullet comment, the track information about the bullet comment's birth, the space information occupied by the bullet comment on the track, and the disappearance position information of the bullet comment on the track.

Exemplarily, the birth track and the birth position of the new bullet comment may be determined in the following several ways.

In an implementation, a size of an interval between adjacent bullet comments that have been generated in each track is determined based on the display information of the bullet comments that have been generated in the application. A free interval available for the new bullet comment is determined based on the length of the new bullet comment and the size of an interval between the adjacent bullet comments that have been generated in each track, where the free interval is greater than or equal to the length of the new bullet comment. A target free interval is determined from the free interval available for the new bullet comment, and a position is determined from the target free interval based on the length of the new bullet comment as the birth position of the new bullet comment. A track where the target free interval is located is the birth track of the new bullet comment.

When the free interval is searched for, the bullet comment on each track is accessed. When display information of the bullet comment on each track is accessed, the size of an interval between the adjacent bullet comments that have been generated is determined based on the space information occupied by the two adjacent bullet comments that have been generated on the track in an angle order. Specifically, a lower limit angle of the bullet comment that occupies a larger angle interval is subtracted from an upper limit angle of the bullet comment that occupies a smaller angle interval to obtain the size of an interval between the adjacent bullet comments that have been generated. For example, if the angle intervals occupied by the two adjacent bullet comments that have been generated are 10 to 28 degrees and 45 to 50 degrees, the size of an interval between the adjacent bullet comments that have been generated is equal to 45−28=17 degrees. For another example, if the angle intervals occupied by the two adjacent bullet comments that have been generated are 123 to 130 degrees and 135 to 143 degrees, the size of an interval between the adjacent bullet comments that have been generated is equal to 135−130=5 degrees.

After the size of an interval between the two adjacent bullet comments that have been generated is determined, the size of an interval is compared with the length of the new bullet comment. In an implementation, if the free interval is greater than or equal to the length of the new bullet comment, the free interval is determined as an available free interval. If the free interval is less than the length of the new bullet comment, the free interval is determined as an unavailable free interval. For the foregoing example, assuming that the length of the new bullet comment is 10 degrees, a size of a free interval is 17 degrees, and a size of another free interval is 5 degrees, the free interval of 17 degrees is the available free interval, and the free interval of 5 degrees is the unavailable free interval.

In another implementation, if the free interval is greater than or equal to the length of the new bullet comment by a preset value, the free interval is determined as the available free interval. If the free interval is greater than or equal to the length of the new bullet comment, but a difference between the free interval and the length of the new bullet comment is less than the preset value, the free interval is determined as the unavailable free interval. Exemplarily, the preset value is 2 degrees or 5 degrees, that is, the free interval is greater than the length of the new bullet comment by 2 degrees or 5 degrees, and can be used as the available free interval.

The new bullet comment may have no available free interval, or may have one or more available free intervals.

Because the bullet comments change dynamically, some bullet comments disappear, and some new bullet comments appear. Therefore, the size of the free interval also changes dynamically. When there is no available free interval for the new bullet comment, the free interval between the adjacent bullet comment is determined again. Alternatively, one or more existing bullet comment are deleted to obtain the available free interval. For example, the bullet comment that has been generated with a generation time farthest from the current time is deleted based on the generation time of the bullet comment that has been generated. After the deletion of the bullet comment, a possible free interval may be generated.

When the bullet comment has one available free interval, the available free interval is determined as the target free interval.

When the bullet comment has a plurality of available free intervals, one of the plurality of available free intervals is selected as the target free interval. One interval may be randomly selected from the plurality of available free intervals, or one interval may be selected from the plurality of available free intervals according to a preset rule. For example, an interval with a largest or smallest free interval is selected from the plurality of available free intervals as the target free interval. Alternatively, an interval closest to the length of the new bullet comment is selected from the plurality of available free intervals as the target free interval.

After the target free interval is determined, a position is determined from the target free interval based on the length of the new bullet comment as the birth position of the new bullet comment. The new bullet comment needs to be completely located in the target free interval. Assuming that the target free interval is 28 to 45 degrees and the length of the new bullet comment is 10 degrees, an angle may be selected from 28 to 35 degrees as the birth angle of the new bullet comment.

In an implementation 2, a birth interval of the new bullet comment is obtained, and the birth track and the birth position of the new bullet comment are determined based on the length of the new bullet comment, the birth interval of the new bullet comment, and the display information of the bullet comment that has been generated in the application.

In this manner, the birth interval of the new bullet comment is limited, and the new bullet comment can only be born in the angle interval. The bullet comment is born in the fixed angle interval, so that the user can quickly and accurately discover the newly born bullet comment, preventing the user from missing the new bullet comment.

In an optional manner, the birth interval of the new bullet comment is set by the user. A setting entry of the birth interval of the new bullet comment is provided in the bullet comment function, and the user enters a setting page through the setting entry and can select the birth interval of the new bullet comment on the setting page. Therefore, the requirements of different users for the birth interval of the bullet comment can be met.

In another optional manner, the birth interval of the new bullet comment is determined based on information of a sending user of the new bullet comment.

Exemplarily, the track is divided into a host interval and a guest interval, the host interval is a birth interval of the bullet comment sent by the user of the primary viewing angle, and the guest interval is a birth interval of the bullet comment sent by the user of the non-primary viewing angle. In response to the sending user of the new bullet comment being the user of the primary viewing angle, the birth interval of the new bullet comment is determined as the host interval. In response to the sending user of the new bullet comment being the user of the non-primary viewing angle, the birth interval of the new bullet comment is determined as the guest interval.

The host interval and the guest interval do not overlap. For example, the host interval is 0 to 90 degrees, and the guest interval is 21 to 360 degrees. Alternatively, the host interval is 30 to 150 degrees, and the remaining interval is the guest interval.

Optionally, the host interval includes a plurality of sub-intervals, and the sub-intervals have different weights; and/or the guest interval includes a plurality of sub-intervals, and the sub-intervals have different weights.

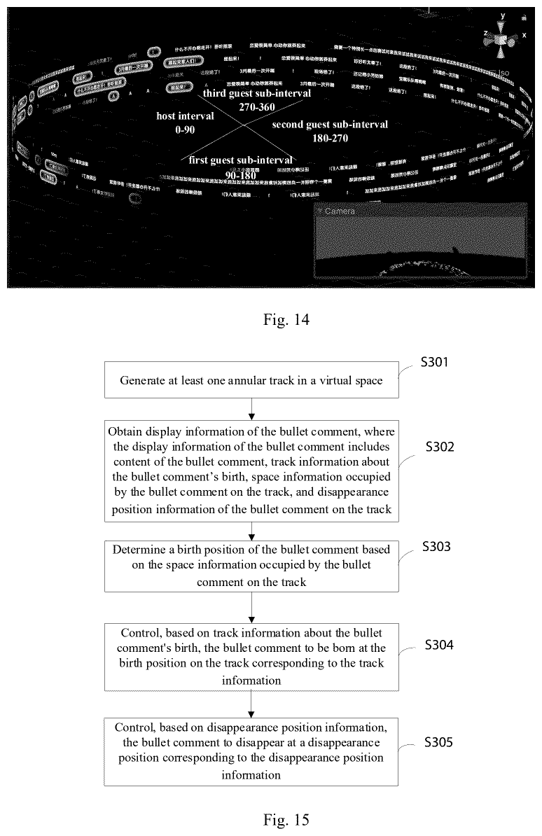

FIG. 14 is a schematic diagram of a host interval and a guest interval of a track. As shown in FIG. 14, 360 degrees are divided into four intervals, that is, one host interval and three guest intervals. An angle range of the host interval is 0 to 90 degrees, an angle range of a first guest sub-interval is 90 to 180 degrees, an angle range of a second guest sub-interval is 180 to 270 degrees, and an angle range of a third guest sub-interval is 270 to 360 degrees. The host bullet comment is born in the host interval, and the guest bullet comment may be born in one of the three guest sub-intervals.

When the host interval includes a plurality of sub-intervals, one of the plurality of sub-intervals included in the host interval is determined as the birth interval of the new bullet comment based on weights of the plurality of sub-intervals included in the host interval.

When the guest interval includes a plurality of sub-intervals, one of the plurality of sub-intervals included in the guest interval is determined as the birth interval of the new bullet comment based on weights of the plurality of sub-intervals included in the guest interval.

For the host interval and the guest interval, a larger weight of the sub-interval indicates a higher probability that the sub-interval is selected as the birth interval of the new bullet comment.

Optionally, one of the host interval and the guest interval is selected in the following manner: assuming that there are a total of n sub-intervals, a value of n is greater than or equal to 2, a weight of each sub-interval is greater than or equal to 0, and a sum of the weights of all the sub-intervals is 1. When a sub-interval is selected, a random number r between (0, 1] is generated, and the n intervals are traversed until a cumulative weight is greater than or equal to r. A current sub-interval is determined as the birth interval of the new bullet comment.

In an example manner, the birth track and the birth position of the new bullet comment may be determined in the following manner: a size of an interval between adjacent bullet comments that have been generated in each track is determined based on the display information of the bullet comment that has been generated in the application. A free interval available for the new bullet comment is determined based on the length of the new bullet comment and the size of an interval between the adjacent bullet comments that have been generated in each track, where the free interval is greater than or equal to the length of the new bullet comment. A first free interval that has an intersection with the birth interval of the new bullet comment is determined from the free interval available for the new bullet comment. A target free interval is determined from the first free interval. A position is determined from the target free interval based on the length of the new bullet comment as the birth position of the new bullet comment. A track where the target free interval is located is the birth track of the new bullet comment.

This manner is similar to the implementation 1, and a difference lies in: after the free interval available for the new bullet comment is determined, an intersection between the free interval available for the new bullet comment and the birth interval of the new bullet comment is determined, and the first free interval that has the intersection with the birth interval of the new bullet comment is obtained from the free interval available for the new bullet comment. Then, the target free interval is determined from the first free interval, so that it can be ensured that the birth position of the new bullet comment falls within the birth interval of the new bullet comment.

In another example manner, a size of an interval between adjacent bullet comments that have been generated in the birth interval of the new bullet comment is determined based on the birth interval of the new bullet comment and the display information of the bullet comment that has been generated in the application. A free interval available for the new bullet comment is determined based on the length of the new bullet comment and the size of an interval between the adjacent bullet comments that have been generated in the birth interval of each track, where the free interval is greater than or equal to the length of the new bullet comment. A target free interval is determined from the free interval available for the new bullet comment, and a position is determined from the target free interval based on the length of the new bullet comment as the birth position of the new bullet comment.

Compared with the implementation 1, this manner only needs to determine the size of an interval between the adjacent bullet comments that have been generated in the birth interval of the new bullet comment.

In the foregoing implementations, the target free interval determined from the plurality of tracks may be located on any one of the plurality of tracks, and the track where the target free interval is located is determined as the birth track of the new bullet comment.

Optionally, the user may also specify the birth track of the new bullet comment when sending the new bullet comment, or the user pre-sets the birth track of the new bullet comment. For example, the user sets one track or a plurality of tracks in the bullet comment function as the birth track of the new bullet comment. Correspondingly, the free interval can be determined only on the track set by the user.

S203: Obtain a disappearance position of the new bullet comment.

In an implementation, the disappearance position of the new bullet comment is determined based on the birth position of the new bullet comment. For example, the disappearance position of the new bullet comment is spaced apart from the birth position of the new bullet comment by a fixed angle, for example, 92 degrees, 120 degrees, 180 degrees, 200 degrees, or the like. After the birth angle of the new bullet comment is determined, the fixed interval is added to the birth angle of the new bullet comment to obtain a disappearance angle of the new bullet comment.

In another implementation, the disappearance position of the new bullet comment is a fixed angle. No matter where the bullet comment is born, the bullet comment disappears at the fixed angle.

In yet another implementation, the disappearance position of the new bullet comment is related to the birth interval of the new bullet comment, different angle intervals correspond to different disappearance positions, and the disappearance position of the new bullet comment is determined based on the birth interval of the new bullet comment and a correspondence between the angle interval and the disappearance position.

S204: Generate the display information of the new bullet comment based on the birth track, the birth position, the length, and the disappearance position of the new bullet comment.

The display information of the new bullet comment includes the content of the new bullet comment, the track information where the new bullet comment is born, the space information occupied by the new bullet comment on the track, and the disappearance position information of the new bullet comment on the track. When the space information occupied by the new bullet comment on the track is an angle interval occupied by the new bullet comment on the track, the angle interval is determined based on the birth angle and the length of the new bullet comment. If the space information occupied by the new bullet comment on the track is the birth position and the length of the new bullet comment, the display information of the new bullet comment is directly generated.

After the display information of the new bullet comment is generated, the new bullet comment is displayed on the annular track based on the display information of the new bullet comment. The display information of the new bullet comment is sent to the server for storage. If there is other information of the new bullet comment, the display information and the other information of the new bullet comment are both sent to the server for storage. The other information may include but is not limited to information of a sending user of the new bullet comment, a sending time of the new bullet comment, and the like.

In this embodiment, the length of the new bullet comment is obtained based on the content of the new bullet comment, and the birth track and the birth position of the new bullet comment are determined based on the length of the new bullet comment and the display information of the bullet comment that has been generated in the application; the disappearance position of the new bullet comment is obtained; the display information of the new bullet comment is generated based on the birth track, the birth position, the length, and the disappearance position of the new bullet comment, and the new bullet comment is displayed on the track based on the display information of the new bullet comment. The birth position of the new bullet comment that is determined based on the length of the new bullet comment and the display information of the bullet comment that has been generated in the application can prevent the new bullet comment from overlapping the bullet comment that has been generated.

Based on Embodiment 1 and Embodiment 2, Embodiment 3 of the present disclosure provides a method for obtaining display information of a new bullet comment. This embodiment is used to illustrate a specific manner of displaying the bullet comment on the annular track based on the display information of the bullet comment. FIG. 15 is a flowchart of a method for obtaining display information of a new bullet comment according to Embodiment 3 of the present disclosure. As shown in FIG. 15, the method provided in this embodiment includes the following steps.

S301: Generate at least one annular track in a virtual space.

S302: Obtain display information of the bullet comment, where the display information of the bullet comment includes content of the bullet comment, track information about the bullet comment's birth, space information occupied by the bullet comment on the track, and disappearance position information of the bullet comment on the track.

S303: Determine a birth position of the bullet comment based on the space information occupied by the bullet comment on the track.

When the space information occupied by the bullet comment on the track is an angle interval occupied by the bullet comment on the track, a start angle or a lower limit angle of the angle interval is determined as a birth angle of the bullet comment.

S304: Control, based on track information about the bullet comment's birth, the bullet comment to be born at the birth position on the track corresponding to the track information.

After the birth track and the birth angle of the bullet comment that are determined, the bullet comment is controlled to appear at the birth angle on the track.

S305: Control, based on disappearance position information, the bullet comment to disappear at a disappearance position corresponding to the disappearance position information.

Optionally, the bullet comment is born at the birth position in a fade-in manner, and the bullet comment disappears at the disappearance position in a fade-out manner. The fade-in means that a process of the bullet comment from nothing to being completely displayed is slowly presented. The fade-out means that a process of the bullet comment from being completely displayed to nothing is slowly presented. The user can intuitively see the process of the bullet comment from nothing to something and from something to nothing.

For example, if a length of a bullet comment is 10 degrees, a birth angle of the bullet comment is 20 degrees, and a disappearance angle of the bullet comment is 120 degrees, the bullet comment initially occupies an angle of 10 to 20 degrees. As the bullet comment moves, a part greater than 20 degrees fades in until the entire part greater than 20 degrees is completely displayed. Then, as the bullet comment moves, a part greater than 120 degrees fades out until an occupied angle is 120 to 130 degrees at an end moment, and the bullet comment completely fades out. Then, the bullet comment is removed.

Therefore, it is also necessary to maintain fade-in data and fade-out data of each bullet comment. The fade-in data is used to describe a start fade-in degree and a fade-in interval angle, and the fade-out data is used to describe a start fade-out degree and a fade-out interval angle.

Exemplarily, the fade-in and fade-out data of each bullet comment satisfy the following three rules: (1) the fade-in and fade-out data of each bullet comment are determined when the bullet comment is born and do not change; (2) the fade-in data of each bullet comment is no longer needed after the bullet comment is completely displayed; and (3) the fade-out data of each bullet comment is needed only when the bullet comment is about to disappear, and is no longer needed after the bullet comment completely disappears.

Fading in and fading out of the bullet comment is completed in a shader. There is no concept of each bullet comment in the shader, but only a simple mesh vertex. According to the rules (2) and (3) of the fade-in and fade-out data, the fade-in and fade-out data of all bullet comments need to be aggregated together. When the shader processes a bullet comment, the fade-in and fade-out data are created only when the bullet comment is actually rotated to a corresponding angle, so as to prevent affecting other bullet comments.

Specifically, a StructuredBuffer in the shader may be used to transmit the fade-in and fade-out data. The fade-in and fade-out data include the following information: a center of a circle, a display area array of all bullet comments, a quantity of display areas, and a track row height.

The center of the circle is a center of a circle of a track where the bullet comment is located, and an angle of the center of the circle is used to calculate an angle of the vertex.

The display area array of each bullet comment is delimited as a float4, and includes a reference angle, an interval angle increment, a y-axis center coordinate, and a fade-in degree. The quantity of display areas is used to describe a total number of the display area array of all bullet comments, and the quantity of display areas is equal to a total number of the bullet comments.

The reference angle is the birth angle or the disappearance angle of the bullet comment. The interval angle increment is the length of the bullet comment. The fade-in degree is used to control a length of an interval in which the transparency gradually changes from 0 to 1 in an interval of [the reference angle, the reference angle+the reference angle increment]. The fade-in degree reflects a fade-in and fade-out effect of the bullet comment, and the fade-in and fade-out effect of all bullet comments are the same.

The interval angle increment is a positive value or a negative value. When the interval angle increment is a positive value, a fade-in process is corresponding. When the interval angle increment is a negative value, a fade-out process is corresponding.

Exemplarily, the fade-in degree is 5, the birth angle of the bullet comment is 20 degrees, and the disappearance angle of the bullet comment is 120 degrees. Therefore, a fade-in interval is 20 to 25 degrees, and a fade-out interval is 115 to 120 degrees. That is, in the fade-in process, the transparency of the bullet comment gradually increases between 20 and 25 degrees. In the fade-out process, the transparency of the bullet comment gradually decreases between 115 and 120 degrees.

In a process from the birth to the disappearance of the bullet comment, a total of three stages are divided: a birth stage, a normal movement stage, and a disappearance stage. The birth stage refers to a process of the bullet comment from appearing at a head to being completely displayed at a tail. The normal movement stage is a stage in which the bullet comment is completely displayed. The disappearance stage refers to a process of the bullet comment from disappearing at the head to completely disappearing at the tail. The fade-in degree is greater than 0 in the birth stage and the disappearance stage, and the fade-in degree is 0 in the normal movement stage of the bullet comment.

The track row height is used to calculate on which track a pixel is located. A highest point and a lowest point of the track in a vertical direction may be calculated based on the track row height and the y-axis center coordinate.

The shader includes a vertex shader and a fragment (frag) shader. The vertex shader is configured to perform matrix transformation on input data to generate position information, generate a per-vertex color, generate texture coordinates, and send the position information and the texture coordinates to the fragment shader. The fragment shader may calculate an angle of a pixel based on world coordinates of the pixel, and then sequentially calculate the transparency of the pixel by using the display area array of all bullet comments.

To better implement the method for displaying a bullet comment according to the embodiments of the present disclosure, the embodiments of the present disclosure further provide an apparatus for displaying a bullet comment. FIG. 16 is a schematic diagram of a structure of an apparatus for displaying a bullet comment according to Embodiment 4 of the present disclosure. As shown in FIG. 16, the apparatus for displaying a bullet comment 100 may include:
a generation module 11, configured to generate at least one annular track in a virtual space;
an obtaining module 12, configured to obtain display information of the bullet comment, where the display information of the bullet comment includes content of the bullet comment, track information about the bullet comment's birth, space information occupied by the bullet comment on the track, and disappearance position information of the bullet comment on the track; and
a display module 13, configured to display the bullet comment on the annular track based on the display information of the bullet comment, and the bullet comment moves on the annular track.

In some embodiments, when the bullet comment is a new bullet comment generated by the application, the display module 13 is specifically configured to:
obtain a length of the new bullet comment based on content of the new bullet comment;
determine a birth track and a birth position of the new bullet comment based on the length of the new bullet comment and display information of the bullet comment that has been generated in the application;
obtain a disappearance position of the new bullet comment; and
generate display information of the new bullet comment based on the birth track, the birth position, the length, and the disappearance position of the new bullet comment.

In some embodiments, the display module 13 is specifically configured to:
determine a size of an interval between adjacent bullet comments that have been generated in each track based on the display information of the bullet comment that has been generated in the application;
determine a free interval available for the new bullet comment based on the length of the new bullet comment and the size of an interval between the adjacent bullet comments that have been generated in each track, where the free interval is greater than or equal to the length of the new bullet comment; and
determine a target free interval from the free interval available for the new bullet comment, and determine a position from the target free interval based on the length of the new bullet comment as the birth position of the new bullet comment, where a track where the target free interval is located is the birth track of the new bullet comment.

In some embodiments, the display module 13 is specifically configured to:
obtain a birth interval of the new bullet comment; and
determine the birth track and the birth position of the new bullet comment based on the length of the new bullet comment, the birth interval of the new bullet comment, and the display information of the bullet comment that has been generated in the application.

In some embodiments, the display module 13 is specifically configured to:
determine a size of an interval between adjacent bullet comments that have been generated in each track based on the display information of the bullet comment that has been generated in the application;
determine a free interval available for the new bullet comment based on the length of the new bullet comment and the size of an interval between the adjacent bullet comments that have been generated in each track, where the free interval is greater than or equal to the length of the new bullet comment;
determine, from the free interval available for the new bullet comment, a first free interval that has an intersection with the birth interval of the new bullet comment;
determine a target free interval from the first free interval; and
determine a position from the target free interval based on the length of the new bullet comment as the birth position of the new bullet comment, where a track where the target free interval is located is the birth track of the new bullet comment.

In some embodiments, the display module 13 is specifically configured to:

determine the birth interval of the new bullet comment based on information of a sending user of the new bullet comment.

In some embodiments, the track is divided into a host interval and a guest interval, the host interval is a birth interval of the bullet comment sent by a user of a primary viewing angle, and the guest interval is a birth interval of the bullet comment sent by a user of the non-primary viewing angle.

The display module 13 is specifically configured to:
in response to the sending user of the new bullet comment being the user of the primary viewing angle, determine the birth interval of the new bullet comment as the host interval; and
in response to the sending user of the new bullet comment being the user of the non-primary viewing angle, determine the birth interval of the new bullet comment as the guest interval.

In some embodiments, the host interval includes a plurality of sub-intervals, and the sub-intervals have different weights.

The display module 13 is specifically configured to: in response to the sending user of the new bullet comment being the user of the primary viewing angle, determine one of the plurality of sub-intervals included in the host interval as the birth interval of the new bullet comment based on weights of the plurality of sub-intervals included in the host interval.

In some embodiments, the guest interval includes a plurality of sub-intervals, and the sub-intervals have different weights.

The display module 13 is specifically configured to: in response to the sending user of the new bullet comment being the user of the non-primary viewing angle, determine one of the plurality of sub-intervals included in the guest interval as the birth interval of the new bullet comment based on weights of the plurality of sub-intervals included in the guest interval.

In some embodiments, the display module 13 is specifically configured to:
determine a birth position of the bullet comment based on the space information occupied by the bullet comment on the track;
based on track information about the bullet comment's birth, control the bullet comment to be born at the birth position on the track corresponding to the track information; and
based on disappearance position information, control the bullet comment to disappear at a disappearance position corresponding to the disappearance position information.

In some embodiments, the bullet comment is born at the birth position in a fade-in manner, and the bullet comment disappears at the disappearance position in a fade-out manner.

In some embodiments, the moving speeds of the bullet comment on the annular tracks are the same.

In some embodiments, the bullet comment on the annular track do not overlap each other.

In some embodiments, a host bullet comment and a guest bullet comment on the annular track are displayed differently, the host bullet comment is sent by a user of a primary viewing angle, and the guest bullet comment is sent by a user of the non-primary viewing angle.

In some embodiments, when the plurality of annular tracks are provided in the virtual space, the plurality of annular tracks are concentric tracks with different radii.

It should be understood that the apparatus embodiments may correspond to the method embodiments, and similar descriptions may be referred to the method embodiments. To avoid repetition, details are not described herein again.

FIG. 17 is a schematic flowchart of a method for displaying a bullet comment according to an embodiment of the present disclosure. The method for displaying a bullet comment may be performed by an apparatus for displaying a bullet comment, and the apparatus for displaying a bullet comment may be composed of hardware and/or software, and may be integrated into an electronic device. In this embodiment of the present disclosure, the electronic device may be any hardware device with a data processing function and an image display function. For example, the electronic device may be an optional VR device, an AR device, an MR device, or an XR device. This is not specifically limited in the present disclosure.

As shown in FIG. 17, the method includes the following steps.

S1101: obtaining a content scene in a virtual space.

In the present disclosure, the content scene may be understood as an interactive scene provided by the virtual space to the user, for example, a 180-degree semi-scene interactive scene or a 360-degree panoramic interactive scene. This is not specifically limited here.

Optionally, after the user starts the electronic device, the electronic device may enter a corresponding virtual space based on an operation of the user, and display, in the virtual space, picture content corresponding to the virtual space to the user. In this embodiment of the present disclosure, if the picture content presented in the virtual space is a live video stream, the virtual space may be understood as a live broadcast room where an anchor is located. If the picture content presented in the virtual space is an ordinary video stream, the virtual space may be understood as a video playing room.

Before the picture content is displayed, the electronic device in the present disclosure first performs a continuous multi-frame recognition operation on the picture content to be displayed, to determine a content scene corresponding to the picture content, that is, determine the content scene of the virtual space. Alternatively, the content scene of the virtual space may be determined based on identification information of the virtual space entered by the user, and the like. This is not specifically limited here.

The identification information of the virtual space may be any information that can uniquely determine an identity of the virtual space, for example, a virtual space number or a virtual space name. This is not specifically limited here.

In some implementations, when the content scene of the virtual space is determined based on the identification information of the virtual space in the present disclosure, the following manners may be included, but are not limited to:

### Manner 1

When a mapping relationship between the identification information of the virtual space and the content scene is configured in the electronic device in advance, the electronic device may query, in a mapping relationship between the identification information of the virtual space and the content scene in configuration information, for the content scene that has a mapping relationship with the identification information of the virtual space based on the identification information of the virtual space.

### Manner 2

Considering that when information is configured on the electronic device, if there are too many configuration parameters, a large amount of memory resources are occupied, resulting in a reduction in available running resources that can be provided when the electronic device runs, thereby affecting the running smoothness of the electronic device and the like.

Therefore, optionally, the present disclosure stores the mapping relationship between the identification information of the virtual space and the content scene on a server that establishes a communication connection with the electronic device. In this way, when the electronic device needs to obtain the content scene of any virtual space, the electronic device may send its own identification information and the identification information of the virtual space to be queried to the server, so that the server can query, in the prestored mapping relationship between the identification information of the virtual space and the content scene, for the content scene that has a mapping relationship with the identification information of the virtual space to be queried based on the received identification information of the virtual space to be queried. Then, the server sends the queried scene content to the electronic device based on the identification information of the electronic device, so that the electronic device obtains the content scene of the virtual space. The identification information of the electronic device may be any information that can uniquely determine an identity of the electronic device, for example, an electronic device number or a serial number of the electronic device.

In this embodiment, the server that establishes the communication connection with the electronic device may be optionally a background server or a cloud server. This is not specifically limited here.

It should be understood that the mapping relationship between the identification information of the virtual space and the content scene may optionally further include type information of the content scene.

S1102: determining a target display manner of the bullet comment based on the content scene.

In this embodiment of the present disclosure, the target display manner includes a target surrounding manner, or the target surrounding manner and a target hierarchical presentation manner.

The target surrounding manner may be optionally one of a landscape scrolling manner, a radian surrounding manner, a semi-scene surrounding manner, and a panoramic surrounding manner.

It should be understood that the landscape scrolling manner may be optionally scrolling from one side of a screen of the electronic device to the other side, for example, scrolling from the right side of the screen to the left side.

The radian surrounding manner may be optionally displaying the bullet comment at any angle less than 180 degrees, so as to implement the radian surrounding manner.

The semi-scene surrounding manner may be understood as a display manner of displaying the bullet comment in a 180-degree surrounding manner.

The panoramic surrounding manner may be understood as a display manner of displaying the bullet comment in a 360-degree surrounding manner.

Considering different content scenes, different viewing angles may be presented to the user. Therefore, in the present disclosure, the target display manner adapted to the content scene may be determined based on the obtained content scene, and the bullet comment in different display manners is intelligently presented to the user based on the content scene, so as to enrich the display manners of the bullet comment, thereby enhancing the interactive interest of the user and improving the interactive experience of the user.

In some implementations, the present disclosure may determine the target display manner of the bullet comment based on a type of the content scene.

It should be understood that the type of the content scene in the present disclosure may include but is not limited to at least one of the following: a long-distance scene, a short-distance scene, a semi-scene (180-degree semi-scene), a panoramic scene (360-degree panoramic scene), a long-distance semi-scene, a long-distance panoramic scene, a short-distance semi-scene, and a short-distance panoramic scene.

The long-distance scene may be optionally a scene at a distance greater than a preset distance from the user. The preset distance in the present disclosure may be flexibly set based on an actual application requirement, for example, 3 meters, 5 meters, or 8 meters. Exemplarily, the long-distance scene in the present disclosure may be a stage at a distance greater than 3 meters from the user; or a drama at a distance greater than 5 meters from the user; or another performance at a distance greater than 6 meters from the user.

The short-distance scene may be optionally a scene at a distance less than or equal to the preset distance from the user. Exemplarily, the short-distance scene in the present disclosure may be a 1V1 scene at a distance less than 3 meters from the user; or a chat scene at a distance less than 5 meters from the user.

In some implementations, when the content scene of the virtual space is obtained, a type of the content scene may also be obtained; or the type of the content scene is determined based on the obtained content scene. In this case, the present disclosure may determine the target display manner corresponding to the content scene type based on the type of the content scene. For example, the target display manner may be found in a mapping relationship between the content scene type and the display manner based on the content scene type.

It should be noted that the mapping relationship between the content scene type and the display manner in the present disclosure may be pre-configured on the electronic device side, or may be stored on a server that establishes a communication connection with the electronic device. This is not specifically limited here.

S1103: displaying the bullet comment in the virtual space based on the target display manner.

If the target display manner is the target surrounding manner, the present disclosure displays the bullet comment in the virtual space based on the target surrounding manner.

If the target display manner is the target surrounding manner and the target hierarchical presentation manner, the present disclosure displays the bullet comment in the virtual space based on the target surrounding manner and the target hierarchical presentation manner.

It should be noted that the bullet comment displayed in the virtual space in the present disclosure may be bullet comment information posted by the user, or may be bullet comment information posted by another user in the same virtual space. This is not specifically limited here.

Considering the tidiness of displaying the bullet comment in the virtual space, a bullet comment presentation area is usually divided in the virtual space, so that the bullet comment sent for the picture content presented in the virtual space can be uniformly presented in the bullet comment presentation area, thereby facilitating viewing the bullet comment information about the picture content. Therefore, when the bullet comment is displayed in the virtual space based on the target display manner in the present disclosure, the bullet comment may be optionally displayed on the bullet comment presentation area in the virtual space.

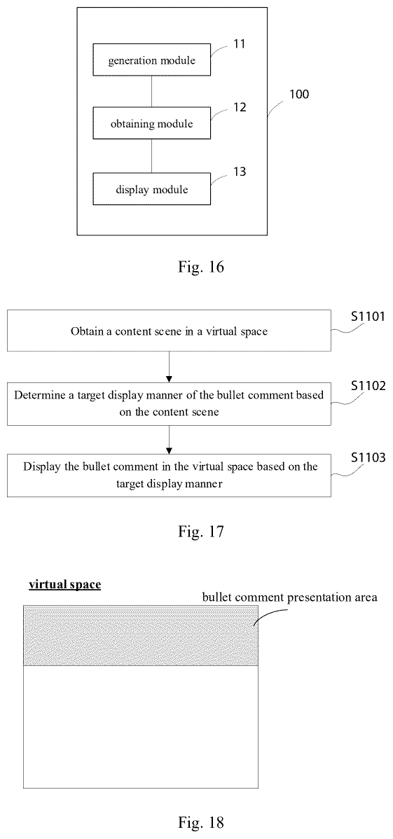

In the present disclosure, the bullet comment presentation area may be an upper area in the virtual space (for example, as shown in FIG. 18), or may be another blank area in the virtual space. This is not specifically limited here.

According to the technical solution provided in this embodiment of the present disclosure, the content scene of the virtual space is obtained, the target display manner of the bullet comment is determined based on the content scene, and then the bullet comment is displayed in the virtual space based on the target display manner. In the present disclosure, the target display manner of the bullet comment is adapted based on the content scene of the virtual space, and the bullet comment is displayed based on the target display manner, so that a diversified display effect of the bullet comment displayed in the virtual space is implemented, the display manner of the bullet comment is enriched, the display cost of the bullet comment is saved, and the interactive experience of the user is improved.

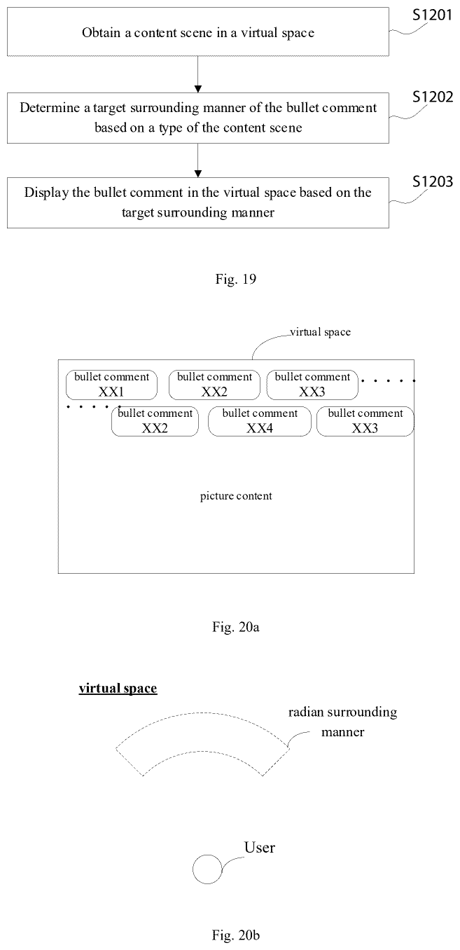

In an optional implementation of the present disclosure, considering that the target display manner of the bullet comment is the target surrounding manner, or the target surrounding manner and the target hierarchical presentation manner, the following further explains and describes determining, in the present disclosure, the target display manner of the bullet comment as the target surrounding manner with reference to FIG. 19.

As shown in FIG. 19, the method may include the following steps.

S1201: Obtain a content scene in a virtual space.

S1202: Determine a target surrounding manner of the bullet comment based on a type of the content scene.

Considering that there may be various types of the content scene, for example, including but not limited to the following: a long-distance scene, a short-distance scene, a semi-scene (180-degree semi-scene), a panoramic scene (360-degree panoramic scene), a long-distance semi-scene, a long-distance panoramic scene, a short-distance semi-scene, and a short-distance panoramic scene.

Therefore, in some implementations, the bullet comment surrounding manner corresponding to each content scene type may be pre-set based on the foregoing various content scene types. Further, a mapping relationship between each content scene type and the corresponding bullet comment surrounding manner is established. Then, the established mapping relationship between the content scene type and the bullet comment surrounding manner is configured on the electronic device or stored on the server, to lay a foundation for subsequently determining the target surrounding manner of the bullet comment based on the type of the content scene.

In this embodiment of the present disclosure, the bullet comment surrounding manner may include but is not limited to the following: a landscape scrolling manner, a radian surrounding manner, 180-degree surrounding, 360-degree surrounding, and the like. This is not limited here. The radian of the radian surrounding manner refers to any radian less than 180 degrees. This is not limited here.

In some implementations, the mapping relationship between the content scene type and the bullet comment surrounding manner established in the present disclosure may be optionally shown in Table 1 below:

TABLE 1

| Type of content scene | Bullet comment surrounding manner |
|---|---|
| Long-distance scene | Landscape scrolling manner |
| Short-distance scene | Radian surrounding manner |
| Semi-scene (180 degrees) | Semi-scene (180 degrees) surrounding |
| | manner |
| Panoramic scene (360 degrees) | Panoramic (360 degrees) surrounding |
| | manner |
| Long-distance semi-scene | Semi-scene (180 degrees) surrounding |
| | manner |
| Long-distance panoramic scene | Panoramic (360 degrees) surrounding |
| | manner |
| Short-distance semi-scene | Semi-scene (180 degrees) surrounding |
| | manner |
| Short-distance panoramic scene | Panoramic (360 degrees) surrounding |
| | manner |

It should be noted that when the bullet comment surrounding manner corresponding to each content scene type is pre-set based on the foregoing various content scene types, the setting may be performed multiple times manually or automatically, to set an optimal surrounding manner for each content scene type. For example, when the surrounding manner is set for the content scene type of the long-distance scene, the landscape scrolling manner, the radian surrounding manner, the 180-degree surrounding manner, and the 360-degree surrounding manner may be sequentially set, and the bullet comment “Hello” is displayed based on each set surrounding manner. Then, a display effect of the bullet comment “Hello” displayed based on each surrounding manner is determined, and one with the best display effect is selected as the target surrounding manner for the long-distance scene.

The display effect of the bullet comment displayed based on each surrounding manner may be determined by naked eyes, or may be determined by acquiring a bullet comment display image, and performing image analysis processing (for example, analyzing the definition of the bullet comment display image) on the bullet comment display image to determine the quality of the bullet comment display image, and then determining the bullet comment display effect based on the quality of the bullet comment display image. The image analysis processing may use a traditional analysis algorithm or strategy. This is not specifically limited here.

It should be understood that the bullet comment surrounding manner set for each content scene type in the present disclosure may also be flexibly adjusted based on an actual presentation requirement. This is not specifically limited here. For example, the landscape scrolling manner corresponding to the long-distance scene is adjusted to a 360-degree full-screen surrounding manner.

Further, after the content scene is obtained, the bullet comment surrounding manner that has a mapping relationship with the obtained type of the content scene may be found in the mapping relationship between the content scene type and the bullet comment surrounding manner based on the type of the content scene, and the bullet comment surrounding manner is determined as the target surrounding manner of the bullet comment.

In some implementations, determining the target surrounding manner of the bullet comment based on the type of the content scene in the present disclosure may include the following cases.

### Case 1

In response to the type of the content scene being the long-distance scene, the target surrounding manner of the bullet comment is determined as the landscape scrolling manner in the mapping relationship between the content scene type and the bullet comment surrounding manner based on the long-distance scene.

### Case 2

In response to the type of the content scene being the short-distance scene, the target surrounding manner of the bullet comment is determined as the radian surrounding manner in the mapping relationship between the content scene type and the bullet comment surrounding manner based on the short-distance scene.

### Case 3

In response to the type of the content scene being the semi-scene, the target surrounding manner of the bullet comment is determined as the semi-scene surrounding manner in the mapping relationship between the content scene type and the bullet comment surrounding manner based on the semi-scene.

### Case 4

In response to the type of the content scene being the panoramic scene, the target surrounding manner of the bullet comment is determined as the panoramic surrounding manner in the mapping relationship between the content scene type and the bullet comment surrounding manner based on the panoramic scene.

### Case 5

In response to the type of the content scene being the long-distance semi-scene, the target surrounding manner of the bullet comment is determined as the semi-scene surrounding manner in the mapping relationship between the content scene type and the bullet comment surrounding manner based on the long-distance semi-scene.

### Case 6

In response to the type of the content scene being the long-distance panoramic scene, the target surrounding manner of the bullet comment is determined as the panoramic surrounding manner in the mapping relationship between the content scene type and the bullet comment surrounding manner based on the long-distance panoramic scene.

### Case 7

In response to the type of the content scene being the short-distance semi-scene, the target surrounding manner of the bullet comment is determined as the semi-scene surrounding manner in the mapping relationship between the content scene type and the bullet comment surrounding manner based on the short-distance semi-scene.

### Case 8

In response to the type of the content scene being the short-distance panoramic scene, the target surrounding manner of the bullet comment is determined as the panoramic surrounding manner in the mapping relationship between the content scene type and the bullet comment surrounding manner based on the short-distance panoramic scene.

S1203: Display the bullet comment in the virtual space based on the target surrounding manner.

Optionally, when the bullet comment is displayed in the virtual space in the present disclosure, each bullet comment track may be first adjusted or the bullet comment on each bullet comment track may be adjusted based on the target surrounding manner. Then, the bullet comment is displayed based on a bullet comment track that is adjusted, or the bullet comment that is adjusted is displayed based on the bullet comment track, so that a diversified display effect of the bullet comment is implemented.

As an optional implementation, displaying the bullet comment in the virtual space is specifically implemented as follows.

### Manner 1

Adjust a surrounding manner of each bullet comment track based on the determined target surrounding manner. The bullet comment is displayed on a bullet comment track that is adjusted.

### Manner 2

Adjust a surrounding manner of the bullet comment on each bullet comment track based on the determined target surrounding manner. The bullet comment that is adjusted is displayed on each bullet comment track.

In some implementations, displaying the bullet comment in the virtual space based on the target surrounding manner in the present disclosure may include but is not limited to the following implementations.

### Implementation 1

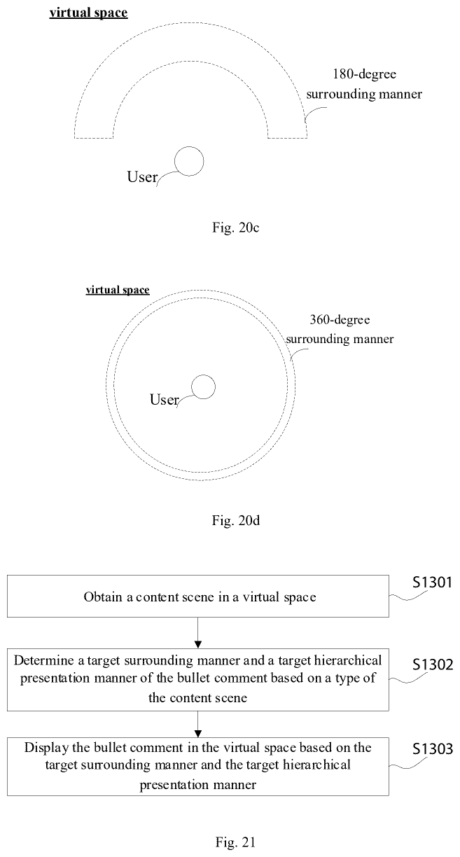

If the target surrounding manner is the landscape scrolling manner, the bullet comments are displayed in the virtual space in the landscape scrolling manner, for example, as shown in FIG. 20a.

### Implementation 2

If the target surrounding manner is the radian surrounding manner, the bullet comments are displayed in the virtual space in the radian surrounding manner, for example, as shown in FIG. 20b.

### Implementation 3

If the target surrounding manner is the 180-degree surrounding manner, the bullet comments are displayed in the virtual space in the 180-degree surrounding manner, for example, as shown in FIG. 20c.

### Implementation 4

If the target surrounding manner is the 360-degree surrounding manner, the bullet comments are displayed in the virtual space in the 360-degree surrounding manner, for example, as shown in FIG. 20d.

In some implementations, when the bullet comment is displayed in the virtual space based on the target surrounding manner in the present disclosure, the bullet comment may also be displayed on the bullet comment presentation area in the virtual space in the target surrounding manner, to ensure the tidiness of the displayed content in the virtual space, thereby facilitating the user to view the displayed bullet comment information.

In the present disclosure, the bullet comment presentation area may be an upper area in the virtual space (for example, as shown in FIG. 18), or may be another blank area in the virtual space. This is not specifically limited here.

Considering that when a large number of bullet comments are displayed in the virtual space, when the bullet comments are displayed in the virtual space based on the target surrounding manner in the present disclosure, the bullet comments may also be displayed in any default bullet comment hierarchical presentation manner, so that the displayed bullet comment have different hierarchies, thereby facilitating the user to view a large amount of bullet comment information.

As an optional implementation of the present disclosure, the default bullet comment hierarchical presentation manner in the present disclosure may include but is not limited to the following: a reciprocating stacking hierarchical presentation manner.

The structure of the reciprocating stacking hierarchical presentation manner may be, for example, an ABAB structure. That is, two bullet comment presentation sizes or depths are used for cyclic presentation.

In other words, displaying the bullet comment based on the reciprocating stacking hierarchical presentation manner (ABAB manner) may make the bullet comment on adjacent bullet comment tracks in the displayed bullet comment information have different hierarchies, thereby facilitating the user to view the bullet comment information, enhancing the interest and three-dimensional effect of the bullet comment presented in the virtual space, and improving the immersive experience of the user in the virtual space.

According to the technical solution provided in this embodiment of the present disclosure, the content scene of the virtual space is obtained, the target display manner of the bullet comment is determined based on the content scene, and then the bullet comment is displayed in the virtual space based on the target display manner. In the present disclosure, the target display manner of the bullet comment is adapted based on the content scene of the virtual space, and the bullet comment is displayed based on the target display manner, so that a diversified display effect of the bullet comment displayed in the virtual space is implemented, the display manner of the bullet comment is enriched, the display cost of the bullet comment is saved, and the interactive experience of the user is improved.

In another optional implementation of the present disclosure, considering that the target display manner of the bullet comment is the target surrounding manner, or the target surrounding manner and the target hierarchical presentation manner, the following further explains and describes determining, in the present disclosure, the target display manner of the bullet comment as the target surrounding manner and the target hierarchical presentation manner with reference to FIG. 21.

As shown in FIG. 21, the method may include the following steps.

S1301: Obtain a content scene in a virtual space.

S1302: Determine a target surrounding manner and a target hierarchical presentation manner of the bullet comment based on a type of the content scene.

To facilitate managing the bullet comment view and subsequent expansion, a track is designed for the bullet comment, to manage the bullet comment through the track. Each row of bullet comments displayed is a bullet comment track. That is, the bullet comment is presented on the bullet comment track, so that parameters such as a display time and a speed of the bullet comment can be flexibly controlled to meet different bullet comment display requirements.

In other words, the bullet comment in the present disclosure may include but is not limited to the following parameters: a quantity of bullet comment tracks.

Considering that the quantity of bullet comment tracks may be one or more (greater than or equal to 2), in response to the quantity of bullet comment tracks being multiple, determining the hierarchical presentation manner of the bullet comment in the present disclosure may include but is not limited to the following situations:

### First Situation

The bullet comment tracks are combined in the virtual space, to determine the hierarchical presentation manner of the bullet comment.

Considering that the bullet comment tracks are independent, the present disclosure may arbitrarily combine the bullet comment tracks in the virtual space based on the independent bullet comment tracks, to obtain different hierarchical presentation manners in a three-dimensional space.

### Second Situation

A target plane is determined in the virtual space, and the bullet comment tracks are set on the target plane, to determine the hierarchical presentation manner of the bullet comment.

Generally, the bullet comment may be displayed on one plane at different sizes. Therefore, optionally, the present disclosure determines any target plane for presenting the bullet comment in the virtual space, and then sets bullet comment tracks of different sizes on the target plane based on a presentation requirement, to obtain different hierarchical presentation manners.

Optionally, to enable intelligent and automatic adaptation to the target surrounding manner and the target hierarchical presentation manner corresponding to the content scene based on the content scene in the virtual space, the present disclosure may pre-set the corresponding bullet comment surrounding manner and the corresponding bullet comment hierarchical presentation manner for each content scene type based on various content scene types. Further, a mapping relationship between each content scene type, the bullet comment surrounding manner, and the bullet comment hierarchical presentation manner is established. Then, the established mapping relationship between the content scene type, the bullet comment surrounding manner, and the bullet comment hierarchical presentation manner is configured on the electronic device or stored on the server, to lay a foundation for subsequently determining the target surrounding manner and the target hierarchical presentation manner of the bullet comment based on the type of the content scene.

The bullet comment surrounding manner may include but is not limited to the following: a landscape scrolling manner, a radian surrounding manner, 180-degree surrounding, 360-degree surrounding, and the like. This is not limited here. The radian of the radian surrounding manner refers to any radian less than 180 degrees. This is not limited here.

The bullet comment hierarchical presentation manner may include but is not limited to one of the following: a forward ladder presentation manner (ABCD manner), an inverted ladder presentation manner (DCBA manner), a reciprocating stacking presentation manner (ABAB manner), a 2D slice presentation manner, and the like.

The 2D slice presentation manner refers to a manner of displaying the bullet comment in a two-dimensional plane form on the bullet comment presentation area in the virtual space.

It should be noted that the zoom magnification of each bullet comment track corresponding to the foregoing forward ladder presentation manner, inverted ladder presentation manner, and reciprocating stacking presentation manner may be flexibly adjusted based on an actual requirement. This is not specifically limited here. For example, the adjustment is performed based on a zoom magnification of 0.01 as a start adjustment reference.

To facilitate describing the zoom magnification of the bullet comment track, the following uses an example in which the quantity of bullet comment tracks is four rows.

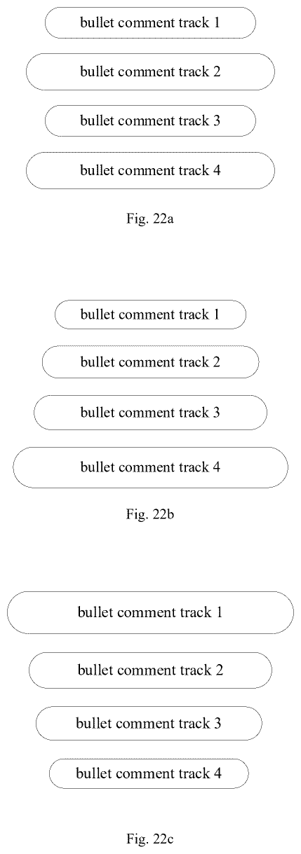

First, for the reciprocating stacking presentation manner, as shown in FIG. 22a, a zoom magnification of the first row is: ×1.00 times; a zoom magnification of the second row is: ×1.03 times; a zoom magnification of the third row is: ×1.00 times; and a zoom magnification of the fourth row is: ×1.03 times.

Second, for the forward ladder presentation manner, as shown in FIG. 22b, the zoom magnification of the first row is: ×1.00 times; the zoom magnification of the second row is: ×0.99 times; the zoom magnification of the third row is: ×0.98 times; and the zoom magnification of the fourth row is: ×0.97 times.

Finally, for the inverted ladder presentation manner, as shown in FIG. 22c, the zoom magnification of the first row is: ×0.97 times; the zoom magnification of the second row is: ×0.98 times; the zoom magnification of the third row is: ×0.99 times; and the zoom magnification of the fourth row is: ×1.00 times.

As an implementation of the present disclosure, the mapping relationship between the content scene type, the bullet comment surrounding manner, and the bullet comment hierarchical presentation manner established in the present disclosure may be optionally shown in Table 2 below:

TABLE 2

| | | Bullet comment |
|---|---|---|
| Type of | Bullet comment | hierarchical |
| content scene | surrounding manner | presentation manner |
| Long-distance | Landscape scrolling | Reciprocating stacking |
| scene | manner | presentation manner |
| Short-distance | Radian surrounding | Inverted ladder presentation |
| scene | manner | manner |
| Semi-scene (180 | Semi-scene (180 degrees) | Forward ladder presentation |
| degrees) | surrounding manner | manner |
| Panoramic scene | Panoramic (360 degrees) | 2D slice presentation |
| (360 degrees) | surrounding manner | manner |
| Long-distance | Semi-scene (180 degrees) | Reciprocating stacking |
| semi-scene | surrounding manner | presentation manner |
| Long-distance | Panoramic (360 degrees) | Reciprocating stacking |
| panoramic scene | surrounding manner | presentation manner |
| Short-distance | Semi-scene (180 degrees) | Inverted ladder presentation |
| semi-scene | surrounding manner | manner |
| Short-distance | Panoramic (360 degrees) | Inverted ladder presentation |
| panoramic scene | surrounding manner | manner |

It should be noted that when the bullet comment surrounding manner and the bullet comment hierarchical presentation manner corresponding to each content scene type are pre-set based on the foregoing various content scene types, the setting may be performed multiple times manually or automatically, to set an optimal surrounding manner and an optimal bullet comment hierarchical presentation manner for each content scene type. For example, when the surrounding manner is set for the content scene type of the short-distance radius scene, the bullet comment surrounding manner may be sequentially set to: the landscape scrolling manner, the radian surrounding manner, the 180-degree surrounding manner, and the 360-degree surrounding manner, and the bullet comment hierarchical presentation manner may be set to: the 2D slice presentation manner, the inverted ladder presentation manner, the forward ladder presentation manner, and the reciprocating stacking presentation manner, and the bullet comment “XX performed so well” is displayed based on each set surrounding manner and each set hierarchical presentation manner. Then, a display effect of the bullet comment “XX performed so well” displayed based on each surrounding manner and each hierarchical presentation manner is determined, and one with the best display effect is selected as the target surrounding manner and the target hierarchical presentation manner for the short-distance radius scene.

It should be understood that the bullet comment surrounding manner and the bullet comment hierarchical presentation manner set for each content scene type in the present disclosure may also be flexibly adjusted based on an actual presentation requirement. This is not specifically limited here.

Further, after the content scene is obtained, the bullet comment surrounding manner and the bullet comment hierarchical presentation manner that have a mapping relationship with the obtained type of the content scene may be found in the mapping relationship between the content scene type, the bullet comment surrounding manner, and the bullet comment hierarchical presentation manner based on the type of the content scene, and the bullet comment surrounding manner is determined as the target surrounding manner of the bullet comment, and the bullet comment hierarchical presentation manner is determined as the target hierarchical presentation manner of the bullet comment.

In some implementations, determining the target surrounding manner and the target hierarchical presentation manner of the bullet comment based on the type of the content scene in the present disclosure may include the following cases.

### First Case

In response to the type of the content scene being the long-distance scene, the target surrounding manner of the bullet comment is determined as the landscape scrolling manner, and the target hierarchical presentation manner of the bullet comment is determined as the reciprocating stacking hierarchical presentation manner in the mapping relationship between the content scene type, the bullet comment surrounding manner, and the bullet comment hierarchical presentation manner based on the long-distance scene.

### Second Case

In response to the type of the content scene being the short-distance scene, the target surrounding manner of the bullet comment is determined as the radian surrounding manner, and the target hierarchical presentation manner of the bullet comment is determined as the inverted ladder presentation manner in the mapping relationship between the content scene type, the bullet comment surrounding manner, and the bullet comment hierarchical presentation manner based on the short-distance scene.

### Third Case

In response to the type of the content scene being the semi-scene, the target surrounding manner of the bullet comment is determined as the semi-scene surrounding manner, and the target hierarchical presentation manner of the bullet comment is determined as the forward ladder presentation manner in the mapping relationship between the content scene type, the bullet comment surrounding manner, and the bullet comment hierarchical presentation manner based on the semi-scene.

### Fourth Case

In response to the type of the content scene being the panoramic scene, the target surrounding manner of the bullet comment is determined as the panoramic surrounding manner, and the target hierarchical presentation manner of the bullet comment is determined as the 2D slice presentation manner in the mapping relationship between the content scene type, the bullet comment surrounding manner, and the bullet comment hierarchical presentation manner based on the panoramic scene.

### Fifth Case

In response to the type of the content scene being the long-distance semi-scene, the target surrounding manner of the bullet comment is determined as the semi-scene surrounding manner, and the target hierarchical presentation manner of the bullet comment is determined as the reciprocating stacking hierarchical presentation manner in the mapping relationship between the content scene type, the bullet comment surrounding manner, and the bullet comment hierarchical presentation manner based on the long-distance semi-scene.

### Sixth Case

In response to the type of the content scene being the long-distance panoramic scene, the target surrounding manner of the bullet comment is determined as the panoramic surrounding manner, and the target hierarchical presentation manner of the bullet comment is determined as the reciprocating stacking hierarchical presentation manner in the mapping relationship between the content scene type, the bullet comment surrounding manner, and the bullet comment hierarchical presentation manner based on the long-distance panoramic scene.

### Seventh Case

In response to the type of the content scene being the short-distance semi-scene, the target surrounding manner of the bullet comment is determined as the semi-scene surrounding manner, and the target hierarchical presentation manner of the bullet comment is determined as the inverted ladder presentation manner in the mapping relationship between the content scene type, the bullet comment surrounding manner, and the bullet comment hierarchical presentation manner based on the short-distance semi-scene.

### Eighth Case

In response to the type of the content scene being the short-distance panoramic scene, the target surrounding manner of the bullet comment is determined as the panoramic surrounding manner, and the target hierarchical presentation manner of the bullet comment is determined as the inverted ladder presentation manner in the mapping relationship between the content scene type, the bullet comment surrounding manner, and the bullet comment hierarchical presentation manner based on the short-distance panoramic scene.

S1303: Display the bullet comment in the virtual space based on the target surrounding manner and the target hierarchical presentation manner.

Considering that the quantity of bullet comment tracks is at least one, in response to the quantity of bullet comment tracks being at least two, when the bullet comment is displayed in the virtual space in the present disclosure, each bullet comment track or the bullet comment on each bullet comment track may be first adjusted based on the target surrounding manner and the target hierarchical presentation manner. Then, the bullet comment is displayed based on a bullet comment track that is adjusted, or the bullet comment that is adjusted is displayed based on the bullet comment track, so that a diversified display effect of the bullet comment is implemented.

As an optional implementation, displaying the bullet comment in the virtual space is specifically implemented as follows.

### Manner 1

Adjust a surrounding manner of each bullet comment track based on the determined target surrounding manner, and adjust a hierarchical presentation manner of each bullet comment track based on the determined target hierarchical presentation manner. Then, the bullet comment is displayed on a bullet comment track that is adjusted.

### Manner 2

Adjust a surrounding manner of the bullet comment on each bullet comment track based on the determined target surrounding manner, and adjust a hierarchical presentation manner of the bullet comment on each bullet comment track based on the determined target hierarchical presentation manner. Then, the bullet comment that is adjusted is displayed on each bullet comment track.

In some implementations, displaying the bullet comment in the virtual space based on the target surrounding manner and the target hierarchical presentation manner in the present disclosure may include but is not limited to the following implementations.

### First Implementation

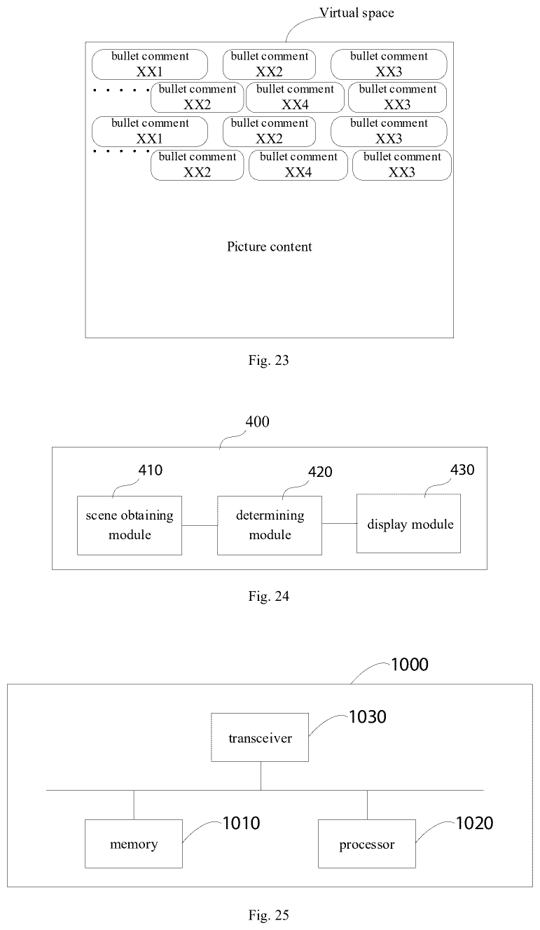

If the target surrounding manner is the landscape scrolling manner and the target hierarchical presentation manner is the reciprocating stacking presentation manner, the bullet comments are displayed in the virtual space in the landscape scrolling manner and the reciprocating stacking presentation manner, for example, as shown in FIG. 23.

### Second Implementation

If the target surrounding manner is the radian surrounding manner and the target hierarchical presentation manner is the inverted ladder presentation manner, the bullet comment is displayed in the virtual space in the radian surrounding manner and the inverted ladder presentation manner.

### Third Implementation

If the target surrounding manner is the 180-degree surrounding manner and the target hierarchical presentation manner is the forward ladder presentation manner, the bullet comment is displayed in the virtual space in the 180-degree surrounding manner and the forward ladder presentation manner.

### Fourth Implementation

If the target surrounding manner is the 360-degree surrounding manner and the target hierarchical presentation manner is the 2D slice presentation manner, the bullet comment is displayed in the virtual space in the 360-degree surrounding manner and the 2D slice presentation manner.

### Fifth Implementation

If the target surrounding manner is the 180-degree surrounding manner and the target hierarchical presentation manner is the reciprocating stacking presentation manner, the bullet comment is displayed in the virtual space in the 180-degree surrounding manner and the reciprocating stacking presentation manner.

### Sixth Implementation

If the target surrounding manner is the 360-degree surrounding manner and the target hierarchical presentation manner is the reciprocating stacking presentation manner, the bullet comment is displayed in the virtual space in the 360-degree surrounding manner and the reciprocating stacking presentation manner.

### Seventh Implementation

If the target surrounding manner is the 180-degree surrounding manner and the target hierarchical presentation manner is the inverted ladder presentation manner, the bullet comment is displayed in the virtual space in the 180-degree surrounding manner and the inverted ladder presentation manner.

### Eighth Implementation

If the target surrounding manner is the 360-degree surrounding manner and the target hierarchical presentation manner is the inverted ladder presentation manner, the bullet comment is displayed in the virtual space in the 360-degree surrounding manner and the inverted ladder presentation manner.

In some implementations, when the bullet comment is displayed in the virtual space based on the target surrounding manner and the target hierarchical presentation manner in the present disclosure, the bullet comment may also be displayed on the bullet comment presentation area in the virtual space in the target surrounding manner and the target hierarchical presentation manner, to ensure the tidiness of the displayed content in the virtual space, thereby facilitating the user to view the displayed bullet comment information.

In the present disclosure, the bullet comment presentation area may be an upper area in the virtual space (for example, as shown in FIG. 18), or may be another blank area in the virtual space. This is not specifically limited here.

According to the technical solution provided in this embodiment of the present disclosure, the content scene of the virtual space is obtained, the target display manner of the bullet comment is determined based on the content scene, and then the bullet comment is displayed in the virtual space based on the target display manner. In the present disclosure, the target display manner of the bullet comment is adapted based on the content scene of the virtual space, and the bullet comment is displayed based on the target display manner, so that a diversified display effect of the bullet comment displayed in the virtual space is implemented, the display manner of the bullet comment is enriched, the display cost of the bullet comment is saved, and the interactive experience of the user is improved. In addition, the target hierarchical presentation manner of the bullet comment determined based on the content scene enables the bullet comment information presented in the virtual space to have obvious hierarchy, thereby facilitating the user to view the bullet comment information, enhancing the interest and diversity of the bullet comment presented in the virtual space, and improving the immersive experience of the user in the virtual space.

An apparatus for displaying a bullet comment provided in an embodiment of the present disclosure is described below with reference to FIG. 24. FIG. 24 is a schematic block diagram of an apparatus for displaying a bullet comment according to an embodiment of the present disclosure.

Specifically, as shown in FIG. 24, the apparatus for displaying a bullet comment 400 includes: a scene obtaining module 410, a determining module 420, and a display module 430.

The scene obtaining module 410 is configured to obtain a content scene in a virtual space;
the determining module 420 is configured to determine a target display manner of bullet comment based on the content scene; and
the display module 430 is configured to display the bullet comment in the virtual space based on the target display manner.

In an optional implementation of this embodiment of the present disclosure, the determining module 420 is specifically configured to:
determine a target surrounding manner of the bullet comment based on a type of the content scene; or
determine the target surrounding manner and a target hierarchical presentation manner of the bullet comment based on the type of the content scene.

In an optional implementation of this embodiment of the present disclosure, the type of the content scene includes at least one of the following: a long-distance scene, a short-distance scene, a semi-scene, and a panoramic scene.

In an optional implementation of this embodiment of the present disclosure, the target surrounding manner is any one of a landscape scrolling manner, a radian surrounding manner, a semi-scene surrounding manner, and a panoramic surrounding manner.

In an optional implementation of this embodiment of the present disclosure, the determining module 420 is specifically configured to:
in response to the type of the content scene being the long-distance scene, determine the target surrounding manner of the bullet comment as the landscape scrolling manner;
in response to the type of the content scene being the short-distance scene, determine the target surrounding manner of the bullet comment as the radian surrounding manner;
in response to the type of the content scene being the semi-scene, determine the target surrounding manner of the bullet comment as the semi-scene surrounding manner; or
in response to the type of the content scene being the panoramic scene, determine the target surrounding manner of the bullet comment as the panoramic surrounding manner.

In an optional implementation of this embodiment of the present disclosure, the parameter of the bullet comment at least includes: a quantity of bullet comment tracks.

In an optional implementation of this embodiment of the present disclosure, in response to the quantity of bullet comment tracks being at least two, the hierarchical presentation manner of the bullet comment is determined by performing the following operations:
the bullet comment tracks are combined in the virtual space, to determine the hierarchical presentation manner of the bullet comment; or
a target plane is determined in the virtual space, and the bullet comment tracks are set on the target plane, to determine the hierarchical presentation manner of the bullet comment.

In an optional implementation of this embodiment of the present disclosure, the target hierarchical presentation manner is any one of a reciprocating stacking presentation manner, an inverted ladder presentation manner, a forward ladder presentation manner, and a 2D slice presentation manner.

In an optional implementation of this embodiment of the present disclosure, the determining module 420 is specifically configured to:
in response to the type of the content scene being the long-distance scene, determine the target surrounding manner of the bullet comment as the landscape scrolling manner, and determine the target hierarchical presentation manner of the bullet comment as the reciprocating stacking hierarchical presentation manner;
in response to the type of the content scene being the short-distance scene, determine the target surrounding manner of the bullet comment as the radian surrounding manner, and determine the target hierarchical presentation manner of the bullet comment as the inverted ladder presentation manner;
in response to the type of the content scene being the semi-scene, determine the target surrounding manner of the bullet comment as the semi-scene surrounding manner, and determine the target hierarchical presentation manner of the bullet comment as the forward ladder presentation manner; or
in response to the type of the content scene being the panoramic scene, determine the target surrounding manner of the bullet comment as the panoramic surrounding manner, and determine the target hierarchical presentation manner of the bullet comment as the 2D slice presentation manner.

In an optional implementation of this embodiment of the present disclosure, the display module 430 is specifically configured to:

display the bullet comment on a bullet comment presentation area in the virtual space based on the target display manner.

In an optional implementation of this embodiment of the present disclosure, the display module 430 is further configured to:
display the bullet comment on a bullet comment presentation area in the virtual space based on the target surrounding manner; or
display the bullet comment on the bullet comment presentation area in the virtual space based on the target surrounding manner and the target hierarchical presentation manner.

In an optional implementation of this embodiment of the present disclosure, the display module 430 is further configured to:
when the bullet comment presentation area includes at least two bullet comment tracks, adjust a surrounding manner of each bullet comment track based on the target surrounding manner, and adjust a hierarchical presentation manner of each bullet comment track based on the target hierarchical presentation manner; and
display the bullet comment on a bullet comment track that is adjusted.

In an optional implementation of this embodiment of the present disclosure, the display module 430 is further configured to:
when the bullet comment presentation area includes at least two bullet comment tracks, adjust a surrounding manner of the bullet comment on each bullet comment track based on the target surrounding manner, and adjust a hierarchical presentation manner of the bullet comment on each bullet comment track based on the target hierarchical presentation manner; and
display the bullet comments that are adjusted on each bullet comment track.

According to the technical solution provided in this embodiment of the present disclosure, the content scene of the virtual space is obtained, the target display manner of the bullet comment is determined based on the content scene, and then the bullet comment is displayed in the virtual space based on the target display manner. In the present disclosure, the target display manner of the bullet comment is adapted based on the content scene of the virtual space, and the bullet comment is displayed based on the target display manner, so that a diversified display effect of the bullet comment displayed in the virtual space is implemented, the display manner of the bullet comment is enriched, the display cost of the bullet comment is saved, and the interactive experience of the user is improved.

It should be understood that the apparatus embodiment may correspond to the foregoing method embodiment, and similar descriptions may be made with reference to the method embodiment. To avoid repetition, details are not described herein again. Specifically, the apparatus 400 shown in FIG. 24 may perform the method embodiment corresponding to FIG. 17, and the foregoing and other operations and/or functions of each module in the apparatus 400 are respectively used to implement corresponding processes in the various methods in FIG. 17. For brevity, details are not described herein again.

The foregoing method embodiment, the apparatus 100, and the apparatus 400 of the embodiments of the present disclosure are described above with reference to the accompanying drawings from the perspective of a functional module. It should be understood that the functional module may be implemented in a form of hardware, may be implemented by an instruction in a form of software, or may be implemented by a combination of a hardware and a software module. Specifically, each step of the method embodiment in the embodiments of the present disclosure may be completed by an integrated logic circuit of hardware in a processor and/or an instruction in a form of software, and steps of the method disclosed in the embodiments of the present disclosure may be directly embodied as completed by execution of a hardware decoding processor, or completed by execution of a combination of the hardware and a software module in the decoding processor. Optionally, the software module may be located in a mature storage medium in the art, such as a random access memory, a flash memory, a read-only memory, a programmable read-only memory, an electrically erasable programmable memory, or a register. The storage medium is located in a memory, and the processor reads information in the memory, and completes the steps in the foregoing method embodiment in combination with the hardware.

FIG. 25 is a schematic block diagram of an electronic device according to an embodiment of the present disclosure.

As shown in FIG. 25, the electronic device 1000 may include:

a memory 1010 and a processor 1020, where the memory 1010 is configured to store a computer program, and transmit program code to the processor 1020. In other words, the processor 1020 may call and run a computer program from the memory 1010, to implement the method in the embodiments of the present disclosure.

For example, the processor 1020 may be configured to perform the foregoing method embodiment based on an instruction in the computer program.

In some embodiments of the present disclosure, the processor 1020 may include but is not limited to the following:

a general-purpose processor, a digital signal processor (Digital Signal Processor, DSP), an application specific integrated circuit (Application Specific Integrated Circuit, ASIC), a field programmable gate array (Field Programmable Gate Array, FPGA), or another programmable logic device, a discrete gate or transistor logic device, or a discrete hardware component.

In some embodiments of the present disclosure, the memory 1010 includes but is not limited to the following:

A volatile memory and/or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), which is used as an external cache. By way of example but not limitation, many forms of RAM are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synch link dynamic random access memory (synch link DRAM, SLDRAM), and a direct rambus random access memory (Direct Rambus RAM, DR RAM).

In some embodiments of the present disclosure, the computer program may be divided into one or more modules, and the one or more modules are stored in the memory 1010 and executed by the processor 1020, to complete the method provided by the present disclosure. The one or more modules may be a series of computer program instruction segments that can complete specific functions, and the instruction segments are used to describe an execution process of the computer program in the electronic device 1000.

As shown in FIG. 25, the electronic device may further include:

a transceiver 1030, where the transceiver 1030 may be connected to the processor 1020 or the memory 1010.

The processor 1020 may control the transceiver 1030 to communicate with another device. Specifically, information or data may be sent to another device, or information or data sent by the another device may be received. The transceiver 1030 may include a transmitter and a receiver. The transceiver 1030 may further include an antenna, and a quantity of antennas may be one or more.

It may be understood that although not shown in FIG. 25, the electronic device 1000 may further include a camera module, a Wi-Fi module, a positioning module, a Bluetooth module, a display, a controller, and the like. Details are not described herein again.

It should be understood that components in the electronic device 1000 are connected to each other through a bus system, where the bus system includes, in addition to a data bus, a power bus, a control bus, and a status signal bus.

The present disclosure further provides a computer storage medium having stored thereon a computer program that, when executed by a computer, causes the computer to perform the method of the foregoing method embodiment.

An embodiment of the present disclosure further provides a computer program product including a computer program/instructions, where the computer program/instructions, when executed by a computer, cause the computer to perform the method of the foregoing method embodiment.

When implemented in software, the foregoing functions may be implemented in whole or in part in the form of a computer program product. The computer program product includes one or more computer instructions. When the computer program instructions are loaded and executed on a computer, the processes or functions described in the embodiments of the present disclosure are all or partially generated. The computer may be a general-purpose computer, a dedicated computer, a computer network, or another programmable apparatus. The computer instructions may be stored in a computer-readable storage medium, or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

A person of ordinary skill in the art may be aware that the modules and algorithm steps of the examples described with reference to the embodiments disclosed herein may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

In the several embodiments provided in the present disclosure, it should be understood that the disclosed system, apparatus, and method may be implemented in other manners. For example, the described apparatus embodiment is merely an example. For example, the module division is merely logical function division and may be other division in actual implementation. For example, a plurality of modules or components may be combined or integrated into another system, or some features may be ignored or not performed. In addition, the displayed or discussed mutual couplings or direct couplings or communication connections may be implemented through some interfaces. The indirect couplings or communication connections between the apparatuses or modules may be implemented in electrical, mechanical, or other forms.

The modules described as separate parts may or may not be physically separate, and parts displayed as modules may or may not be physical modules, and may be located at one position, or may be distributed on a plurality of network units. Some or all of the modules may be selected based on actual requirements to achieve the objectives of the solutions of the embodiments. For example, the functional modules in each embodiment of the present disclosure may be integrated into one processing module, each module may exist alone physically, or two or more modules may be integrated into one module.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1. A method for presenting a bullet comment, applicable in an extended reality (XR) device, comprising:
determining at least one layer of surrounding bullet comment tracks in a virtual space; and
in response to any current bullet comment obtained in the virtual space, determining a presentation position of the current bullet comment in the at least one layer of surrounding bullet comment tracks, and presenting the current bullet comment at the presentation position.

2. The method according to claim 1, wherein the determining at least one layer of surrounding bullet comment tracks in the virtual space comprises:
determining a bullet comment track position in the virtual space based on a relative distance between a user and a bullet comment subject object in the virtual space, and a height of the user; and
generating at least one layer of surrounding bullet comment tracks at the bullet comment track position.

3. The method according to claim 2, wherein the bullet comment track position comprises a track radius base value and a track height from ground base value when a position of the user in the virtual space is used as a track center,
wherein the generating at least one layer of surrounding bullet comment tracks at the bullet comment track position comprises:
determining a corresponding single-layer track height based on the track radius base value, a preset track adapted vertical viewing angle, and a number of track layers;
determining a target height from ground of each layer of surrounding bullet comment tracks based on the track height from ground base value and the single-layer track height; and
generating the at least one layer of surrounding bullet comment tracks based on the track radius base value and the target height from ground of each layer of surrounding bullet comment tracks.

4. (canceled)

5. The method according to claim 1, wherein the determining the presentation position of the current bullet comment in the at least one layer of surrounding bullet comment tracks comprises:
determining the presentation position of the current bullet comment in the at least one layer of surrounding bullet comment tracks based on a bullet comment that has been presented in the at least one layer of surrounding bullet comment tracks,
wherein the determining the presentation position of the current bullet comment in the at least one layer of surrounding bullet comment tracks based on the bullet comment that has been presented in the at least one layer of surrounding bullet comment tracks comprises:
determining a first bullet comment presentable area in the at least one layer of surrounding bullet comment tracks based on explicit presentation areas and implicit presentation areas of the bullet comment that has been presented in the at least one layer of surrounding bullet comment tracks, and an adjacent bullet comment interval that is preset;
determining a presentation start point of the current bullet comment in the first bullet comment presentable area; and
determining a presentation end point of the current bullet comment based on the presentation start point and a bullet comment presentation length that is preset in the virtual space.

6. (canceled)

7. The method according to claim 5, wherein the presentation end point is a position point that is spaced apart from the presentation start point by the bullet comment presentation length in a counterclockwise or clockwise direction along a track where the presentation start point is located,
wherein the presenting the current bullet comment at the presentation position comprises:
rolling and presenting the current bullet comment in the counterclockwise or clockwise direction along the track where the presentation start point is located from the presentation start point based on a preset bullet comment rolling speed in the virtual space; and
canceling presentation of bullet comment content of the current bullet comment that has rolled to the presentation end point at the presentation end point.

8. (canceled)

9. The method according to claim 7, further comprising:
displaying a first bullet comment mask at the presentation start point of the current bullet comment, to present the current bullet comment at the presentation start point by using a first special effect;
displaying a second bullet comment mask at the presentation end point of the current bullet comment, to cancel presentation of the current bullet comment at the presentation end point by using a second special effect; and
controlling the presentation start point to roll along with a last character of the current bullet comment,
wherein the first special effect is used to make the current bullet comment appears by fading in at the presentation start point, and the second special effect is used to make the current bullet comment disappears by fading out at the presentation end point.

10. (canceled)

11. The method according to claim 1, further comprising:
delimiting a plurality of bullet comment production areas in the at least one layer of surrounding bullet comment tracks based on a head orientation of a user in the virtual space, a bullet comment presentation direction in the at least one layer of surrounding bullet comment tracks, and a bullet comment presentation length that is preset in the virtual space, where bullet comment production weights of different bullet comment production areas are different,
wherein the determining the presentation position of the current bullet comment in the at least one layer of surrounding bullet comment tracks, and presenting the current bullet comment at the presentation position comprises:
determining an adaptive bullet comment production area of the current bullet comment and a second bullet comment presentable area in the adaptive bullet comment production area based on a sending object of the current bullet comment and a bullet comment that has been presented in each bullet comment production area;
determining a presentation start point of the current bullet comment in the second bullet comment presentable area;
determining a presentation end point of the current bullet comment based on the presentation start point, the bullet comment presentation direction, and the bullet comment presentation length;
rolling and presenting the current bullet comment in the bullet comment presentation direction from the presentation start point; and
canceling presentation of bullet comment content of the current bullet comment that has rolled to the presentation end point at the presentation end point.

12. (canceled)

13. (canceled)

14. (canceled)

15. The method according to claim 1, further comprising:
obtaining display information of the bullet comment, the display information of the bullet comment comprising content of the bullet comment, track information about the bullet comment's birth, space information occupied by the bullet comment on a track, and disappearance position information of the bullet comment on the track; and
displaying the bullet comment on the at least one layer of surrounding bullet comment tracks based on the display information of the bullet comment, wherein the bullet comment moves on the at least one layer of surrounding bullet comment tracks.

16. The method according to claim 15, wherein in response to the bullet comment being a new bullet comment generated by an application, the obtaining display information of bullet comment comprises:
obtaining a length of the new bullet comment based on a content of the new bullet comment;
determining a birth track and a birth position of the new bullet comment based on a length of the new bullet comment and display information of a bullet comment that has been generated in the application;
obtaining a disappearance position of the new bullet comment; and
generating display information of the new bullet comment based on the birth track, the birth position, the length, and the disappearance position of the new bullet comment.

17. The method according to claim 16, wherein the determining the birth track and the birth position of the new bullet comment based on the length of the new bullet comment and display information of the bullet comment that has been generated in the application comprises:
determining, based on the display information of the bullet comment that has been generated in the application, a size of an interval between adjacent bullet comments that have been generated in each track;
determining, based on the length of the new bullet comment and the size of the interval between adjacent bullet comments that have been generated in each track, an available free interval of the new bullet comment, wherein the free interval is greater than or equal to the length of the new bullet comment; and
determining a target free interval from the available free interval of the new bullet comment, and determining a position in the target free interval as the birth position of the new bullet comment based on the length of the new bullet comment, wherein a track where the target free interval is located is the birth track of the new bullet comment.

18. The method according to claim 16, wherein the determining the birth track and the birth position of the new bullet comment based on the length of the new bullet comment and display information of the bullet comment that has been generated in the application comprises:
obtaining a birth interval of the new bullet comment; and
determining the birth track and the birth position of the new bullet comment based on the length of the new bullet comment, the birth interval of the new bullet comment, and the display information of the bullet comment that has been generated in the application,
wherein the determining the birth track and the birth position of the new bullet comment based on the length of the new bullet comment, the birth interval of the new bullet comment, and the display information of the bullet comment that has been generated in the application comprises:
determining, based on the display information of the bullet comment that has been generated in the application, a size of an interval between adjacent bullet comments that have been generated in each track;
determining, based on the length of the new bullet comment and the size of the interval between the adjacent bullet comments that have been generated in each track, an available free interval of the new bullet comment, wherein the free interval is greater than or equal to the length of the new bullet comment;
determining a first free interval that has an intersection with the birth interval of the new bullet comment from the available free interval of the new bullet comment;
determining a target free interval from the first free interval; and
determining a position in the target free interval as the birth position of the new bullet comment based on the length of the new bullet comment, wherein a track where the target free interval is located is the birth track of the new bullet comment.

19. (canceled)

20. (canceled)

21. The method according to claim 18, wherein the track is divided into a host interval and a guest interval, the host interval is a birth interval of bullet comment sent by a user of a primary viewing angle, and the guest interval is a birth interval of bullet comment sent by a user of a non-primary viewing angle; and
the obtaining the birth interval of the new bullet comment comprises:
in response to the sending user of the new bullet comment being the user of the primary viewing angle, determining the birth interval of the new bullet comment as the host interval; or
in response to the sending user of the new bullet comment being the user of the non-primary viewing angle, determining the birth interval of the new bullet comment as the guest interval.

22. (canceled)

23. (canceled)

24. (canceled)

25. (canceled)

26. (canceled)

27. (canceled)

28. (canceled)

29. (canceled)

30. The method according to claim 1, further comprising:
obtaining a content scene in the virtual space;
determining a target display manner of the bullet comment based on the content scene; and
displaying the bullet comment in the virtual space based on the target display manner.

31. The method according to claim 30, wherein the determining the target display manner of bullet comment based on the content scene comprises:
determining a target surrounding manner of the bullet comment based on a type of the content scene; or
determining the target surrounding manner and a target hierarchical presentation manner of the bullet comment based on the type of the content scene.

32. The method according to claim 31, wherein the type of the content scene comprises at least one of a long-distance scene, a short-distance scene, a semi-scene, and a panoramic scene, and wherein the target surrounding manner is any one of a landscape scrolling manner, a radian surrounding manner, a semi-scene surrounding manner, and a panoramic surrounding manner.

33. (canceled)

34. The method according to claim 32, wherein the determining the target surrounding manner of the bullet comment based on the type of the content scene comprises:
in response to the type of the content scene being the long-distance scene, determining the target surrounding manner of the bullet comment as a landscape scrolling manner;
in response to the type of the content scene being the short-distance scene, determining the target surrounding manner of the bullet comment as a radian surrounding manner;
in response to the type of the content scene being the semi-scene, determining the target surrounding manner of the bullet comment as a semi-scene surrounding manner; or
in response to the type of the content scene being the panoramic scene, determining the target surrounding manner of the bullet comment as a panoramic surrounding manner.

35. The method according to claim 30, wherein a parameter of the bullet comment at least includes: a quantity of bullet comment tracks,
wherein in response to the quantity of bullet comment tracks being at least two, a hierarchical presentation manner of the bullet comment is determined by:
combining bullet comment tracks in the virtual space, to determine the hierarchical presentation manner of the bullet comment; or
determining a target plane in the virtual space, and setting the bullet comment tracks on the target plane, to determine the hierarchical presentation manner of the bullet comment.

36. (canceled)

37. The method according to claim 30, wherein the target hierarchical presentation manner is any one of a reciprocating stacking presentation manner, an inverted ladder presentation manner, a forward ladder presentation manner, and a 2D slice presentation manner,
wherein the determining the target surrounding manner and the target hierarchical presentation manner of the bullet comment based on the type of the content scene comprises:
in response to a type of the content scene being a long-distance scene, determining a target surrounding manner of the bullet comment as a landscape scrolling manner, and determining a target hierarchical presentation manner of the bullet comment as the reciprocating stacking presentation manner;
in response to a type of the content scene being a short-distance scene, determining the target surrounding manner of the bullet comment as a radian surrounding manner, and determining the target hierarchical presentation manner of the bullet comment as the inverted ladder presentation manner;
in response to a type of the content scene being a semi-scene, determining the target surrounding manner of the bullet comment as a semi-scene surrounding manner, and determining the target hierarchical presentation manner of the bullet comment as the forward ladder presentation manner; or
in response to a type of the content scene being a panoramic scene, determining the target surrounding manner of the bullet comment as a panoramic surrounding manner, and determining the target hierarchical presentation manner of the bullet comment as the 2D slice presentation manner.

38. (canceled)

39. (canceled)

40. (canceled)

41. (canceled)

42. (canceled)

43. (canceled)

44. (canceled)

45. (canceled)

46. An electronic device, comprising:
a processor; and
a memory, configured to store executable instructions of the processor,
wherein the processor is configured to perform a method for presenting a bullet comment by executing the executable instructions, and the method comprises:
determining at least one layer of surrounding bullet comment tracks in a virtual space; and
in response to any current bullet comment obtained in the virtual space, determining a presentation position of the current bullet comment in the at least one layer of surrounding bullet comment tracks, and presenting the current bullet comment at the presentation position.

47. A non-transitory computer-readable storage medium having stored thereon a computer program, wherein when the computer program is executed by a processor, a method for presenting a bullet comment is implemented, and the method comprises:
determining at least one layer of surrounding bullet comment tracks in a virtual space; and
in response to any current bullet comment obtained in the virtual space, determining a presentation position of the current bullet comment in the at least one layer of surrounding bullet comment tracks, and presenting the current bullet comment at the presentation position.

48. (canceled)
